(19) United States
(12) Patent Application Publication
(10) Pub. No.: US 2026/0147728 A1
(43) Pub. Date: May 28, 2026

(54) System and method for batched speculative decoding on a data flow architecture

(71) Applicant: SambaNova Systems, Inc., Palo Alto, CA (US)

(72) Inventors: John LONG, Palo Alto, CA (US); Bo Li, Foster City, CA (US); Reid GOODBAR, Palo Alto, CA (US); Tuowen Zhao, Palo Alto, CA (US); Mingran WANG, San Jose, CA (US); Leon ZHANG, Palo Alto, CA (US)

(73) Assignee: SambaNova Systems, Inc., Palo Alto, CA (US)

(21) Appl. No.: 19/396,316

(22) Filed: Nov. 20, 2025

Related U.S. Application Data
(60) Provisional application No. 63/723,672, filed on Nov. 22, 2024.

(51) Int. Cl. G06F 15/78; G06F 9/32; G06F 12/0877

(52) U.S. Cl. CPC G06F 15/7867; G06F 9/321; G06F 12/0877

(57) ABSTRACT

In one implementation, a computer implemented method for predicting new information based on a previous information may include creating a draft cache and a target cache within a memory of the computer wherein the draft cache and the target cache have a fixed length. The method may include storing tokens representing the information into the caches, the storing may start at a leftmost cache location. The method may also include forming a mask and an index or pointer for each cache. As new entries are formed, they are added to the caches, and the masks and pointers are updated to include to the entries that are added.

### PRIORITY CLAIM TO PRIOR PROVISIONAL FILING

This application claims priority to prior filed Provisional Application No. 63/723,672 entitled “BATCHED SPECULATIVE DECODING ON A DATA FLOW ARCHITECTURE” filed on Nov. 22, 2024, having a docket number of SBNV1204USP01, and having common inventors Long et al. which is hereby incorporated herein by reference

### CROSS-REFERENCE TO RELATED DOCUMENTS AND APPLICATIONS

This application is related to the following published documents:
Prabhakar et al., “Plasticine: A Reconfigurable Architecture for Parallel Patterns,” ISCA '17, Jun. 24-28, 2017, Toronto, ON, Canada;
Koeplinger et al., “Spatial: A Language and Compiler for Application Accelerators,” Proceedings of the 39th ACM SIGPLAN Conference on Programming Language Design and Implementation (PLDI), Proceedings of the 43rd International Symposium on Computer Architecture, 2018;
U.S. patent application Ser. No. 18/218,562, published as US 2024/0020261, entitled “Peer-To-Peer Route Through In A Reconfigurable Computing System,” filed on Jul. 5, 2023;
U.S. patent application Ser. No. 18/383,718, published as US 2024/0073129, entitled “Peer-To-Peer communication between Reconfigurable Dataflow Units,” filed Oct. 25, 2023;
U.S. patent application Ser. No. 16/239,252, now U.S. Pat. No. 10,698,853, entitled “Virtualization of a Reconfigurable Data Processor,” filed Jan. 3, 2019;
U.S. patent application Ser. No. 18/107,613, published as US 2023/0251839, entitled “Head Of Line Blocking Mitigation In A Reconfigurable Data Processor,” filed on Feb. 9, 2023, and
U.S. patent application Ser. No. 18/107,690, published as US 2023/0251993, entitled “Two-Level Arbitration in a Reconfigurable Processor,” filed on Feb. 9, 2023.

### BACKGROUND

### Technical Field

The technology disclosed relates to improved management of data for speculative predictions of, among other things, a reconfigurable data processor and relates to processing instructions and moving data in at least a coarse grain reconfigurable processor.

### Context

Large Language Models were previously deployed for a variety of purposes including search and summarization operations and various other applications. In some examples, the applications may have included receiving inputs and predicting what information the next input may include. Previous systems often used variable sequence lengths in order to support the predictions. In some applications, the variable sequence lengths resulted in data being stored out of order and also slowed system operations which sometime resulted in inaccurate predictions. Thus, it is useful to have a process that can improve the system performance and provide a more accurate prediction.

### BRIEF DESCRIPTION OF THE DRAWINGS

FIG. 1 is a simplified block diagram illustrating an example of an implementation of a computer system including a computer processor and a host processor ;

FIG. 2 illustrates portions of an example of an implementation of a computer system that may include a host processor and a graphics processing unit processor;

FIG. 3 illustrates a simplified block diagram of an example of portions of an implementation of a computer system that may be implemented as a coarse grained reconfigurable system having a CGRA (Coarse Grain Reconfigurable Architecture);

FIG. 4 illustrates an example of portions of an implementation of a CGR array (CGRA) including one or more Arrays of CGR units (ACGRUs) connected to one or more ALN(s);

FIG. 5 illustrates an example of portions of an implementation of a CGR array (CGRA) including an Array of CGR units (ACGRUs) connected in an ALN that may be an implementation of at least a portion of the coarse grain reconfigurable array of FIG. 4;

FIG. 6 illustrates a simplified block diagram of an example of an implementation of a program memory unit (PMU) that may be one or more of the CGRUs of FIG. 5;

FIGS. 7-12 illustrate simplified examples of some system elements at various stages of a process for receiving an example input data and using speculative decoding to predict subsequent data; and

FIG. 13 includes a flowchart illustrating in a general manner some operations and data formed for speculative decoding data and predicting subsequent data.

### DETAILED DESCRIPTION

As will be seen hereinafter, an improved speculative decoding architecture and technique are described wherein the speculative decoding architecture establishes optimized word arrangements and buffers that improve the processing speed of a computer system.

As used herein, the phrase “one of” should be interpreted to mean exactly any one of the listed items. For example, the phrase “one of A, B, and C” should be interpreted to mean any of:
only A, only B, or only C
As used herein, the phrases “at least one of” and “one or more of” should be interpreted to mean one or more items. For example, the phrase “at least one of A, B, or C” or the phrase “one or more of A, B, or C” should be interpreted to mean any number of the items of A, B, and/or C. The phrase “at least one of A, B, and C” means at least one of A and at least one of B and at least one of C.

Unless otherwise specified, the use of ordinal adjectives “first”, “second”, “third”, etc., to describe an object, merely refers to different instances or classes of the object and does not imply any ranking or sequence. The terms first, second, third and the like in the Claims or/and in the Detailed Description, as used in a portion of a name of an element, are used for distinguishing between similar elements and not necessarily for describing a sequence, either temporally, spatially, in ranking or in any other manner. It is to be understood that the terms so used are interchangeable under appropriate circumstances and that the implementations or embodiments described herein are capable of operation in other sequences than described or illustrated herein.

The terms “comprising” and “consisting of” have different meanings in this application. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be indirect through galvanic, capacitive, inductive, electromagnetic, optical, or through any other electrical element or process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item or circuit elements can be configured to perform the task even when the unit/circuit/component is not currently on or active. In general, the circuitry that forms the structure corresponding to “configured to” may include hardware circuits, and may further be controlled by switches, logical or analog electronics, fuses, bond wires, metal masks, firmware, and/or software. Similarly, various items may be described as performing a task or tasks, for convenience in the description. Such descriptions should be interpreted as including the phrase configured to. Reciting an item that is configured to perform one or more tasks is expressly intended not to invoke 35 U.S.C. 112, paragraph (f) interpretation for that unit/circuit/component. More generally, the recitation of any element is expressly intended not to invoke 35 U.S.C. $ 112, paragraph (f) interpretation for that element unless the language “means for” or “step for” is specifically recited.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase “based on” is thus synonymous with the phrase “based at least in part on.”

The words “during”, “while”, and “when” as used herein relating to an operation are not exact terms that mean an action takes place instantly upon an initiating action but that there may be some small but reasonable delay(s), such as various propagation delays, between the reaction that is initiated by the initial action. Additionally, the term “while” means that a certain action occurs at least within some portion of a duration of the initiating action. When used in reference to a state of a signal or a logic state, the term “asserted” means an active state of the signal or logic state and the term “negated” means an inactive state of the signal or logic state. The actual voltage value or logic state (such as a “1” or a “0 ” of the logic state or the “high” or “low” voltage value of a signal) depends on whether positive or negative logic is used. Thus, asserted can be either a high voltage or a high logic or a low voltage or low logic depending on whether positive or negative logic is used and negated may be either a low voltage or low state or a high voltage or high logic depending on whether positive or negative logic is used. Herein, a positive logic convention is used wherein “asserted” is a high logic state or high voltage value, but those skilled in the art understand that a negative logic convention could also be used.

The terms “close”, “near”, and “about” refer to being within minus or plus 10% of an indicated value, unless explicitly specified otherwise. The use of the word “approximately” or “substantially” means that a value of an element has a parameter that is expected to be close to a stated value or position. However, as is well known in the art there are always minor variances that prevent the values or positions from being exactly as stated. It is well established in the art that variances of up to at least ten per cent (10%) (and up to twenty per cent (20%) for some elements including semiconductor doping concentrations and shapes of sidewalls/distances of doped regions) are reasonable variances from the ideal goal of exactly as described.

For simplicity and clarity of the illustration(s), elements in the figures are not necessarily to scale, some of the elements may be exaggerated for illustrative purposes, and the same reference numbers in different figures denote the same elements, unless stated otherwise. Cross hatched regions or cross-hatching in the drawings is used merely to assist in distinguishing boundaries of different regions and does not imply any type of materials. Additionally, descriptions and details of well-known steps and elements may be omitted for simplicity of the description. Neither the figures nor the Detailed Description are intended to limit the scope as claimed. Instead, they merely represent examples of different implementations.

Reference to “one embodiment” or “an embodiment” or an “implementation” means that a particular feature, structure, or characteristic described in connection with the embodiment or implementation is included in at least one implementation. Thus, appearances of the phrases “in one implementation” or “in an implementation” in various places throughout this specification are not necessarily all referring to the same implementation, but in some cases it may. Furthermore, the particular features, structures or characteristics may be combined in any suitable manner and in a wide variety of different implementations, as would be apparent to one of ordinary skill in the art, in one or more implementations.

The embodiments or implementations illustrated and described hereinafter may have implementations and/or may be practiced in the absence of any element which is not specifically disclosed herein.

The terms “IC, integrated circuit, monolithically integrated circuit” include at least a single semiconductor die which may be delivered as a bare die or as a packaged circuit. For the purposes of this document, the term integrated circuit also includes packaged circuits that may include multiple semiconductor dies, stacked dies, or multiple-die substrates. Such constructions are now common in the industry, produced by the same supply chains, and for the average user often indistinguishable from monolithic circuits.

The following terms or acronyms used herein are defined at least in part as follows:
AGCU—address generator (AG) and coalescing unit (CU).
AI—artificial intelligence.
AIR—arithmetic or algebraic intermediate representation.
ALN—array-level network.
Buffer—an intermediate storage of data.
CGR—coarse-grained reconfigurable. A property of, for example, a system, a processor (CGRP), an architecture (see CGRA), an array, or a unit in an array (CGRU). This property distinguishes the system, etc., from field-programmable gate arrays (FPGAs), which can implement digital circuits at the gate level and are therefore fine-grained configurable.
CGRA—coarse-grained reconfigurable architecture. A data processor architecture that includes one or more arrays (CGR arrays) of CGR units (CGRUs).
CGR Array or ACGRU—an array of CGR units (ACGRUs), coupled with each other through one or more array-level networks (ALNs). ACGRU may be coupled with external elements via a top-level network (TLN). A CGR array can physically implement the nodes and edges of a Graph.
Compiler—a translator that processes statements written in a programming language to machine language instructions for a computer processor. A compiler may include multiple stages to operate in multiple steps. Each stage may create or update an intermediate representation (IR) of the translated statements. For the purposes of this disclosure, an assembler that generates configuration data for a CGR processor from low-level so-called assembly language code can also be referred to as a compiler.
Computation graph—some algorithms can be represented as computation graphs. As used herein, computation graphs are a type of directed graphs comprising nodes that represent mathematical operations/expressions and edges that indicate dependencies between the operations/expressions. For example, with machine learning (ML) algorithms input layer nodes assign variables, output layer nodes represent algorithm outcomes, and hidden layer nodes perform operations on the variables. Edges represent data (e.g., scalars, vectors, tensors) flowing between operations. In addition to dependencies, the computation graph reveals which operations and/or expressions can be executed concurrently.
Dataflow Graph or Graph—a computation graph that includes one or more loops that may be nested, and wherein nodes can send messages to nodes in earlier layers to control the dataflow between the layers. For example, a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
CGR unit or CGRU—a circuit that can be configured and reconfigured to locally either or both of store data (e.g., a memory unit or a PMU), or to execute a programmable function (e.g., a compute unit or a PCU). A CGR unit includes hardwired functionality that performs a limited number of functions used in computation graphs and dataflow graphs. Further examples of CGR units include a CU and an AG, which may be combined in an AGCU. Some implementations include CGR switches, whereas other implementations may include regular switches.
CU—coalescing unit.
Dataflow Graph—a computation graph that includes one or more loops that may be nested, and wherein nodes can send messages to nodes in earlier layers to control the dataflow between the layers.
Graph—a collection of nodes connected by edges. Nodes may represent various kinds of items or operations, dependent on the type of graph. Edges may represent relationships, directions, dependencies, etc. A Graph may include any or all elements of either or both of a Dataflow Graph or a Computational graph.
Datapath—a collection of functional units that perform data processing operations. The functional units may include memory, multiplexers, ALUs, SIMDs, multipliers, registers, buses, etc.
FCMU—fused compute and memory unit—a circuit that includes both a memory unit and a compute unit.
IC—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
A logical CGR array or logical CGR unit—a CGR array or a CGR unit that is physically realizable, but that may not have been assigned to a physical CGR array or to a physical CGR unit on an IC.
Metapipeline—a subgraph of a computation graph or graph that includes a producer operator providing its output as an input to a consumer operator. Metapipelines may be nested, that is, producer operators and consumer operators may include other metapipelines.
ML—machine learning.
Multi-Port Memory—A multi-port memory can include one or more arrays of memory cells that allow for concurrent access to the memory from more than one access port. This can be accomplished in several ways, depending on the implementation, including, but not limited to, a multi-port memory array, multiple banks of memory that allow access to the different banks of memory simultaneously, time multiplexing access to the memory cells from the access port, or a combination thereof.
PCU—pattern compute unit—a compute unit that can be configured to repetitively perform a sequence of operations.
PEF—processor-executable format—a file format suitable for configuring a configurable data processor.
Pipeline—a staggered flow of operations through a chain of pipeline stages. The operations may be executed in parallel and in a time-sliced fashion. Pipelining increases overall instruction throughput. CGR processors may include pipelines at different levels. For example, a compute unit may include a pipeline at the gate level to enable correct timing of gate-level operations in a synchronous logic implementation of the compute unit, and a metapipeline at the graph execution level (typically a sequence of logical operations that are to be repetitively executed) that enables correct timing and loop control of node-level operations of the configured graph. Gate-level pipelines are usually hard wired and unchangeable, whereas metapipelines are configured at the CGR processor, CGR array level, and/or GCR unit level.
Pipeline Stages—a pipeline is divided into stages that are coupled with one another to form a pipe topology.
PMU—pattern memory unit—a memory unit that can locally store data according to a programmed pattern.
PNR—place and route—the assignment of logical CGR units and associated processing/operations to physical CGR units in an array, and the configuration of communication paths between the physical CGR units.
RAIL−reconfigurable dataflow unit (RDU) abstract intermediate language.
SIMD—single-instruction multiple-data—an arithmetic logic unit (ALU) that simultaneously performs a single programmable operation on multiple data elements delivering multiple output results.
TLN—top-level network.

### Implementations

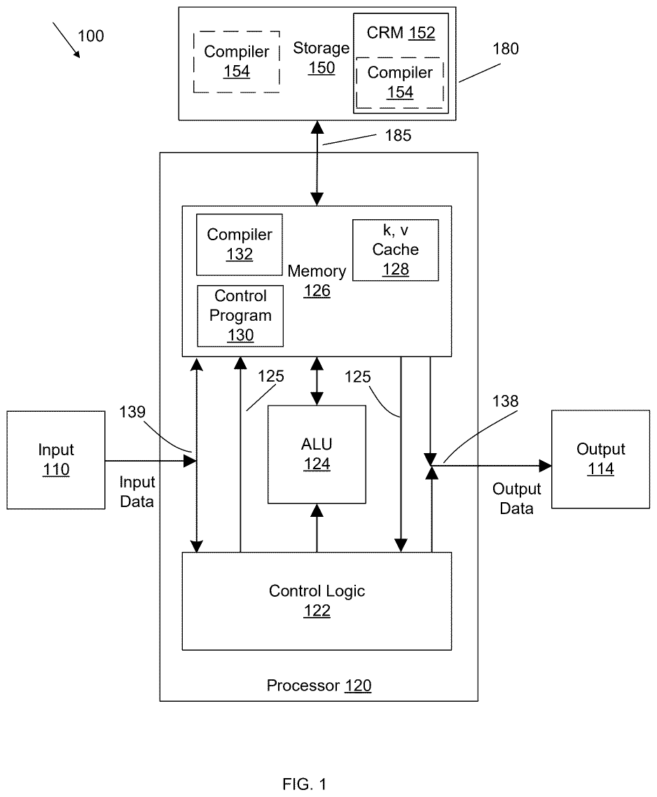

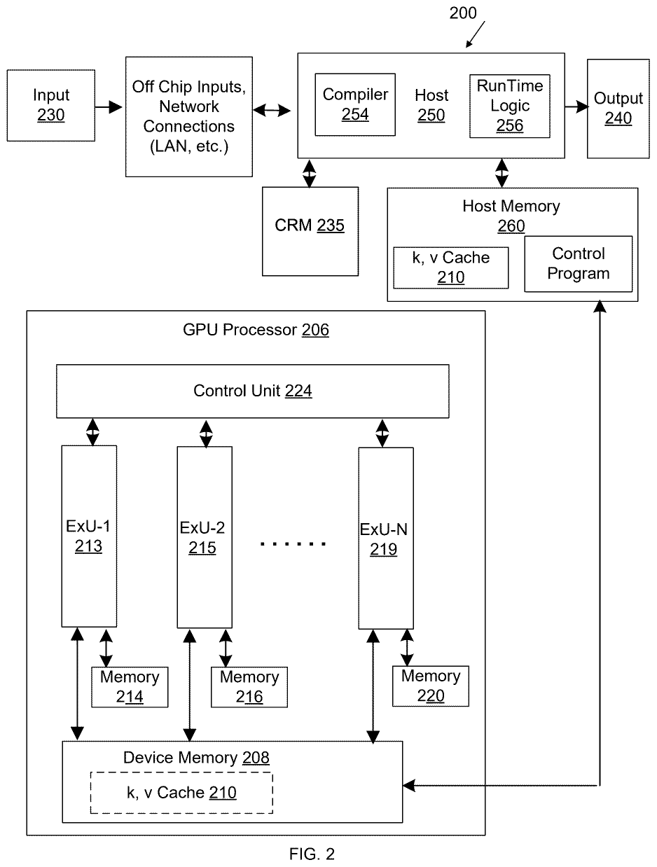

FIG. 1 is a simplified block diagram illustration of an example of an implementation of a computer system 100 including a computer processor 120, and a host processor or host 180. Although the example system 100 is drawn with a single processor 120, and a single host 180, other implementations may have multiple processors. Host 180 may, in some implementations, include a computer such as further described with reference to a host 250 of FIG. 2. Host 180 may include memory storage 150 and may include a non-transitory computer readable medium (CRM) 152. Host 180 may execute runtime logic, as further referenced herein, and may also be used to run computer programs, such as a compiler 154 as described herein, such as in the description of FIG. 2. In some implementations, compiler 154 may run on host 180, or alternately on processor 120.

Processor 120 may have a typical Von-Neuman architecture and may include an ALU 124, a memory 126, and control Logic 122. A portion of memory 126 may include a non-transitory computer-readable medium (CRM). Processor 120 may further include an I/O interface (I/F) 138, and an I/O interface (I/F) 139. Processor 120 may have other architectures in other implementations. Processor 120 may be coupled with I/O interfaces (I/F) 138 and 139 and may include an internal data bus 125. Host 180 communicates with I/O interfaces 138-139 and memory 126 via a system data bus 185. Processor 120 may further include other computational elements, such as a control program or program 130, and memory units that may be connected with system data bus 185 and internal data bus 125 to provide the circuitry for execution of computer program instructions, such as for example a computation graph or a dataflow graph, that may have been derived from a high-level program with user algorithms and functions, such as for example via compiler 154 or 132. The program may include sequencing input data including using a k/v cache 128 for intermediate results of the program. For simplicity of the descriptions, the term “k/v cache” may be used herein to mean “k, v cache”. The high-level program may include a set of procedures, such as learning or inferencing in an AI or ML system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In some implementations, processor 120 may include one or more ICs. In other implementations, a single IC may span multiple elements of processor 120.

FIG. 2 illustrates portions of an example of an implementation of a computer system 200 that may include a host processor or host 250 and a graphics processing unit processor (GPU) 206. A portion of host 250 may have an implementation that may be substantially the same as at least a portion of host 180 (FIG. 1). System 200 may include an input device 230 and an output device 240 for receiving and generating I/O. For example, devices 230 and 240 may be used to receive data for speculative decoding and for outputting the result thereof. System 200 may also include a non-transitory computer-readable medium (CRM) 235 and a host memory 260. A control program or program may be stored in memory 260 or in CRM 235. Host 250 may include a run time logic 256 with capability of executing a complier 254. Input device 230 may comprise a mouse, a keyboard, a voice-to-text device, a sensor, an input port (for example, a universal serial bus (USB) port), and any other input device known in the art. Output device 240 may comprise a monitor, printer, and any other output device known in the art. Furthermore, part or all of input device 230 and output device 240 may be combined in a network interface, such as a Peripheral Component Interconnect Express (PCIe) interface or an Ethernet interface suitable for communicating with processor 206. Input device 230 is coupled with processor 206 to provide input data, which an implementation may store in memory within processor 206.

Processor 206 includes a thread control unit or control unit 224, a device memory 208, and two or more parallel execution units (ExU) illustrated by execution units ExU-1 213, ExU-2 215 through ExU-N 219. The execution units (ExU) are coupled to respective local memory units 214, 216, and 220. Processor 206 may perform a process of sequencing data using one or more of ExUs 213, 215, and 219 and may form a k/v cache 210 within memory 260, or alternately within memory 208, during the process of sequencing the data. Memory 208 may in some implementations comprises memory with fast access, such as static random-access memory (SRAM), whereas host memory 260 may in some implementations comprises memory with slow access, such as dynamic random-access memory (DRAM), flash memory, magnetic disks, optical disks, and any other memory type known in the art. Memory 208 may also or alternatively include a non-transitory computer-readable medium (CRM) for storing computer programs and/or configuration files. The computer programs and/or configuration files may configure host 250 and/or processor 206 to configure the architecture to optimize speculative decoding of data or other operations explained herein.

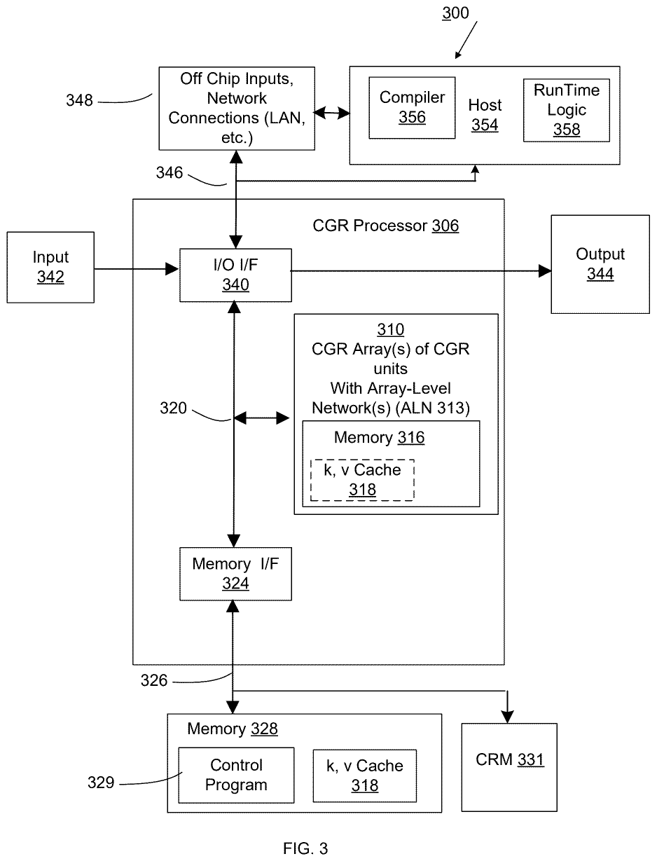

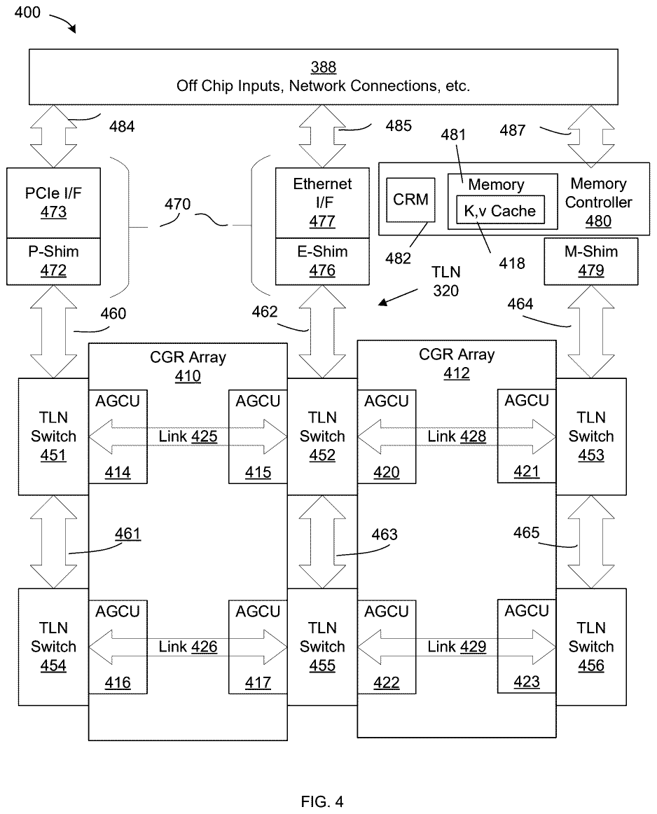

FIG. 3 illustrates a simplified block diagram of an example of portions of an implementation of a computer system that may be implemented as a coarse grained reconfigurable system 300 having a CGRA (Coarse Grain Reconfigurable Architecture). System 300 includes a coarse grained reconfigurable processor (CGRP) 306, a host processor or host 354, and a memory 328. CGRP 306 has a coarse-grained reconfigurable architecture (CGRA) and includes one or more Arrays of CGR units (ACGRUs) 310. For example (as illustrated in FIG. 4), CGRP 306 may include CGR Array1 410 and CGR Array2 412, although other implementations can have any number of arrays or tiles, including a single array or tile. An implementation may include that memory 328 is external to CGRP 306. Memory 328 may be any of various types of memory, such as a high bandwidth memory (HBM) or DDR or other type of memory. An implementation may include that a portion of memory 328 may be used to implement a k/v cache 318. CGRP 306 further may include an I/O interface (I/F) 340, and a memory interface (I/F) 324. Array of CGR units (ACGRUs) 310 is coupled with I/O interface (I/F) 340 and memory interface (I/F) 324 via a top-level network (TLN) 320 that may include one or more data bus(s). Host 354 communicates with I/O interface 340 via system data bus 346, and memory interface 324 may communicate with memory 328 via a memory bus 326. ACGRU 310 may include a memory 316. An implementation of CGRP 306 may alternately include that a portion of memory 316 may be used to implement k/v cache 318. In some implementations, a portion of memory 316 may be included within one or more memory units (Mus or PMUs) of ACGRU 310. ACGRU 310 may further include compute units (CU), programable compute units (PCU), memory units (MU), programable memory units (PMU), and/or fused compute-memory units (CMU) that are connected with an array-level network (ALN) 313 to provide the circuitry for execution of a Graph, such as for example a computation graph or a dataflow graph, that may have been derived from a high-level program with user algorithms and functions. The high-level program may include a set of procedures, such as learning or inferencing in an AI or ML or LLM system. More specifically, the high-level program may include applications, graphs, application graphs, user applications, computation graphs, control flow graphs, dataflow graphs, models, deep learning applications, deep learning neural networks, programs, program images, jobs, tasks and/or any other procedures and functions that may need serial and/or parallel processing. In an implementation, the high-level program may form a Process that includes applications, graphs, dataflow graphs, or other procedures that in operation, such as executing on a processor, may form a method that controls the operation of other algorithms such as an LLM or another model. For example, the Process may include forming or managing parameters used by the other algorithms, The Process may mean the method as specified in the program and associated sequences formed by execution of the program. The Process may include sequencing input data including using k/v cache 318 for intermediate results of the Process. In some implementations, a portion or alternately all of cache 318 may be included in one or more of the CGRUs of ACGRU 310. In some implementations, execution of the Graph or Process may involve using multiple CGRUs of ACGRU 310. In some implementations, CGR processor (CGRP) 306 may include one or more ICs. In other implementations, a single IC may span multiple coarsely reconfigurable data processors. In further implementations, CGR processor (CGRP) 306 may include one or more array of CGR units (ACGRUs) which may be similar to ACGRU 310.

CGR processor (CGRP) 306 may accomplish computational tasks by executing a configuration file (for example, a PEF file). For the purposes of this description, a configuration file may correspond to a dataflow graph, or a translation of a dataflow graph, and may further include initialization data. The configuration file may be stored in a configuration store/logic circuit (Cfg). A compiler, such as for example compiler 356, may compile the high-level program to provide the configuration file. In some implementations described herein, a CGR array or a ACGRU may be configured by programming one or more configuration stores in the configuration store/logic circuit (Cfg) of the CGRUs within the array, such as within ACGRU 310, with all or parts of the configuration file. A single configuration store/logic circuit (Cfg) may be at the level of the CGR processor (CGRP) or the CGR array, or one or more CGRUs of the CGR array may include an individual configuration store/logic circuit (Cfg). The configuration file may include configuration data for the CGR array and CGR units in the CGR array, and link the computation graph to the CGR array. Execution of the configuration file by CGR processor (CGRP) 306 causes ACGRU 310 to implement the user algorithms and functions in the dataflow graph or implement the Process.

CGR processor 306 can be implemented on a single integrated circuit die or on a multichip module (MCM). An IC can be packaged in a single chip module or a multichip module. An implementation may include that at least a portion of memory 328 and cache 318 may be included within the IC. An MCM is an electronic package that may comprise multiple IC dies and other devices, assembled into a single module as if it were a single device. The various dies of an MCM may be mounted on a substrate, and the bare dies of the substrate are electrically coupled to the surface or to each other using for some examples, wire bonding, tape bonding, or flip-chip bonding.

FIG. 4 illustrates an example of portions of an implementation of a CGR array (CGRA) 400, including one or more Arrays of CGR units (ACGRUs) connected to one or more ALN(s), such as for example ALN 313 (FIG. 3). CGRA 400 may be a portion of processor 306 (FIG. 3). For simplicity of the drawings, CGRA 400 is illustrated with two CGR Arrays (CGRAs) 410 and 412. However, CGRA 400 may include fewer or more that two Arrays of CGR units. CGRAs 410 and 412 each include one or more types of CGR units (CGRUs), such as for example FCMUs, PMUs, PCUs, memory units (MU), and/or compute units (CU). In some implementations, some of the CGR units may be PCUs or PMUs. In other implementations, some of the CGR Units (CGRUs) may be an FCMU or memory units and compute units, arranged in a checkerboard pattern. In yet other implementations, the CGRUs may be arranged in different patterns. For examples of the functions of these types of CGRUs, see Prabhakar et al., “Plasticine: A Reconfigurable Architecture for Parallel Patterns”, ISCA 2017, June 24-28, 2017, Toronto, ON, Canada.

CGRAs 410 and 412 may have implementations that may be included as one or more of the ACGRUs describe in the explanation of ACGRU 310 (FIG. 3). Each of CGRAs 410 and 412 has one or more AGCUs (Address Generation and Coalescing Units) 414-417 and 420-423. The AGCUs are nodes on both top level network (TLN) 320 and on array-level networks (ALNs) within their respective CGRAs 410 and 412, and include resources for routing data among nodes on TLN 320 and nodes on the array-level network (ALN) in each CGR array 410 and 412.

TLN 320 may be a packet-switched mesh network using an array of TLN switches 451-456 for communication between agents. Any routing strategy can be used on TLN 320, depending on the implementation, but some implementations may arrange the various components of TLN 320 in a grid and use a row, column addressing scheme for the various components. Such implementations may then route a packet first vertically to the designated row, and then horizontally to the designated destination. Other implementations may use other network topologies and/or routing strategies for TLN 320.

CGRA 410 and 412 may include ALN links that may be similar to or a portion of ALN 313 (FIG. 3). ALN links 425-426, 428-429, and 460-465 allow for communication between elements of CGRA 410, elements of CGRA 412, and through TLN 320 to Shims of other functions of a CGR processor such as CGRP 306 (FIG. 3). Some examples of such Shims include P-Shim 472, E-Shim 476, and M-Shim 479. In some implementations, P-Shim 472, E-Shim 476, and M-Shim 479 may be portions of interfaces 340 and 324 (FIG. 3). Other functions of CGR processor (CGRP) 306 (FIG. 3) may connect to TLN 320 in different implementations, such as additional shims to additional and or different input/output (I/O) interfaces and memory controllers, and other chip logic such as CSRs, configuration controllers, or other functions. Data may travel in packets between the units of CGRAs 410 and 412 on ALN links 425-426, 428-429, and the packets may travel to other elements external to CGRAs 410 and 410 through TLN 320, for example through links 460-465. Top level switches 451 and 452 may, for example, be connected by ALN link 425, TLN switches 451 and P-Shim 472 may be connected by TLN link 460, TLN switches 451 and 454 may be connected by TLN link 461, and TLN switch 453 and M-Shim 479 may be connected by TLN link 464.

P-Shim 472 provides an interface between TLN 320 and PCIe Interface 473, E-Shim 476 provides an interface between TLN 320 and Ethernet Interface 477, which connect to external communication links 484 and 485 which may form part of communication links such as system data bus 346 as shown in FIG. 3. While one P-Shim 472 with PCIe interface 473 and associated PCIe link 484 are shown, implementations can have any number of P-Shims and associated PCIe interfaces and links. M-Shim 479 provides an interface to a memory controller 480. Controller 480 may be coupled to access a memory 481 which may include various types of memory, such as a high-bandwidth memory (HBM), a DDR memory, or other memory. Controller 480 may also have a memory interface 487 and can connect to other memory such as memory 328 of FIG. 3. While only one M-Shim 479 is shown, implementations can have any number of M-Shims and associated memory controllers and memory interfaces. Different implementations may include memory controllers for other types of memory, such as a flash memory controller and/or a high-bandwidth memory (HBM) controller. An implementation may include an interface for a CRM 482. The interfaces for Shims 472, 476, and 479 include resources for routing data among nodes on TLN 320 and external devices, such as high-capacity memory, host processors, other CGRA processors, FPGA devices and so on, that are connected to the interfaces for Shims 472, 476, and 479.

One of the AGCUs in each CGR array in this example may be configured to be a master AGCU (MAGCU), which includes an array configuration load/unload controller for the CGR array. The MAGCU1 (for example AGCU 414) includes a configuration load/unload controller for CGR array 410, and MAGCU2 (for example AGCU 420) includes a configuration load/unload controller for CGR array 412. Some implementations may include more than one array configuration load/unload controller. In other implementations, an array configuration load/unload controller may be implemented by logic distributed among more than one AGCU. In yet other implementations, a configuration load/unload controller can be designed for loading and unloading configuration of more than one CGR array. In further implementations, more than one configuration controller can be designed for configuration of a single CGR array. Also, the configuration load/unload controller can be implemented in other portions of the system, including as a stand-alone circuit on the TLN and the ALN or ALNs.

A data processing operation or other method implemented by a CGR array configuration, such as CGRA 400, may comprise multiple Graphs or subgraphs specifying data processing operations that are distributed among and executed by corresponding CGRUs. For example, CGRA 400 may execute at least a portion of a Process or graph to sequence data and implement speculative decoding of the data received by CGRA 400.

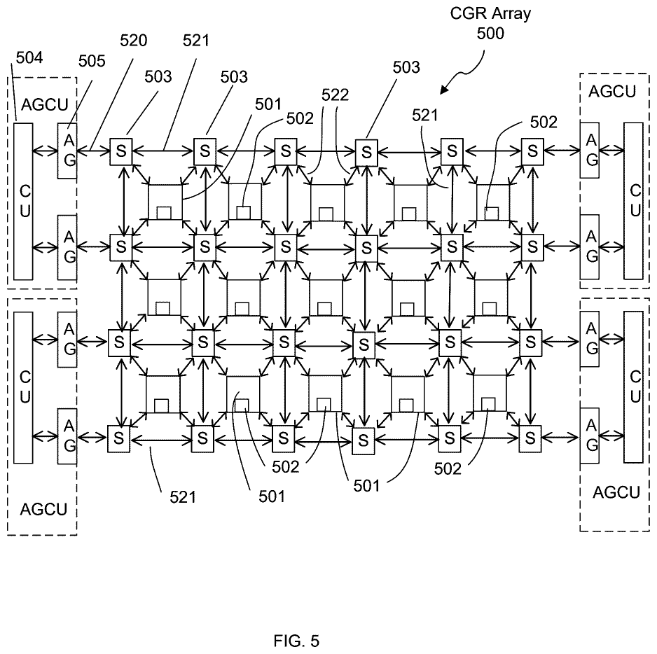

FIG. 5 illustrates an example of portions of an implementation of a CGR array (CGRA) 500, including an Array of CGR units (ACGRUs) connected in an ALN. CGRA 500 includes CGR units (CGRUs) 501. An implementation of CGRA 500 may have an embodiment that may be substantially similar to or alternately the same as CGRA 410 or CGRA 412 of FIG. 4, or alternately may be a portion of ACGRU 310 (FIG. 3).

CGR units (CGRUs) 501 may include a configuration store/logic circuit (Cfg) 502 that includes a set of storage and/or control logic, such as for example registers or flip-flops, that store configuration data. As explained hereinbefore, the configuration data may represent a setup and/or control sequence that may facilitate executing a Graph or a Process. Configuration store/logic circuit (Cfg) 502 may also include status information about the CGRU usable to track progress for execution of a Graph or sub-graph or other portion of the Process. Cfg 502 may further include the source of operands, and the network parameters for the input and output interfaces. A configuration file may be stored within Cfg 502 and may include configuration data representing an initial configuration, or starting state of one or more of the CGRUs, or internal elements of the CGRU, that executes a graph or other high-level program with user algorithms and functions. Program load is the process of initializing the configuration file within the configuration store/logic circuit (Cfg) 502 with the information or data to facilitate the CGRU executing the graph or other the high-level program. Program load may also require loading memory units (MU) and/or PMUs. The configuration file defines a data flow graph including functions in the configurable units and links between the functions in the configurable interconnect. In this manner the configurable units act as sources or destinations of data used by other configurable units providing functional nodes of the graph. Such systems can use external data processing resources including external memory and a processor executing a runtime program, as sources or sinks of data used in the graph.

The ALN of CGR array 500 includes switch units or switches(S) 503, and also includes AGCUs that each may include two address generators (AG) 505 and a shared coalescing unit (CU) 504. Switches(S) 503 are connected among themselves via ALN interconnects 521 and are also connected to a CGRU 501 with ALN interconnects 522. Switches(S) 503 may be coupled with address generators (AG) 505 via ALN interconnects 520. Interconnects 520, 521, and 522 may have an implementation that may be a portion of the ALN within either of CGRA 410 or 412 (FIG. 4). In some implementations, communication channels can be configured as end-to-end connections, and switches 503 may be CGRUs. In other implementations, switches route data via the available links based on address information in packet headers, and communication channels establish as and when needed. An initiating CGRU may be referred to as a source, requestor, initiator, or producer CGRU depending on the type of transaction. The source CGRU may initiate various types of transactions to various resources in a remote CGRU. The remote CGRU may be referred to as a destination, or sink, or consumer, or target CGRU. In some cases, the source CGRU may receive various responses from the destination CGRU.

The ALN of CGRA 500 includes one or more kinds of physical data buses, for example a chunk-level vector bus (e.g., 512 bits wide to transmit 512 bits of data), a word-level scalar bus (e.g., 32 bits wide to transmit 32 bits of data), and a control bus. For instance, ALN interconnects 521 between two switches may include a vector bus interconnect with a word wide bus width, for example 512 bits wide, and a scalar bus interconnect with a bus with a scalar word width, for example 32 bits wide, along with a control bus. The control bus can comprise physical lines separate from the data buses in some implementations. In other implementations, the control bus can be implemented using the same physical lines with a separate protocol or in a time-sharing procedure. A control bus can comprise a configurable interconnect that carries multiple control bits on multiple signal routes designated by configuration bits in the CGRU's configuration file in the configuration store/logic circuit (such as Cfg 502).

Physical data buses may differ in the granularity of data being transferred. In one implementation, a vector bus can carry a transmission that includes 16 channels of 32-bit floating-point data or 32 channels of 16-bit floating-point data (i.e., 512 bits) of data as its payload. An implementation of a scalar bus can have a 32-bit payload and carry scalar operands or control information. The control bus can carry control handshakes such as tokens and other signals. The vector and scalar buses can be packet-switched, where the packets may include headers that indicate a destination of each packet and other information such as sequence numbers that can be used to reassemble a file when the packets are received out of order. Each packet header can contain a destination identifier that identifies the spatial coordinates of the destination switch unit (e.g., the row and column in the array), and an interface identifier that identifies the interface on the destination switch (e.g., North, South, East, West, etc.) used to reach the destination unit.

Each CGRU 501 may have four ports (as illustrated) to interface with switches 503, or any other number of ports suitable for an ALN. Each port may be suitable for receiving and transmitting data, or a port may be suitable for only receiving or only transmitting data. Switch(S) 503 may have eight interfaces. North, South, East, and West interfaces of a switch unit may be used for links between switch units using ALN interconnects 521. Northeast, Southeast, Northwest, and Southwest interfaces of a switch unit may each be used to make a link with a CGRU 501 using one of ALN interconnects 522. Two switches 503 in each CGR array quadrant may have links to an AGCU using ALN interconnects 520. The AGCU coalescing unit arbitrates between the AGs and processes memory requests. Each of the eight interfaces of a switch unit can include a vector interface, a scalar interface, and a control interface to communicate with the vector network, the scalar network, and the control network. In other implementations, a switch unit may have any number of interfaces.

During execution of a graph or subgraph in a CGR array after configuration, data can be sent via one or more switch units and one or more interconnects between the switch units to the CGRUs using the vector bus and vector interface(s) of the one or more switch units on the ALN. A CGR array, such as for example CGRA 410 or 412, may include at least a part of CGR array 500, and any number of other CGR arrays coupled with CGR array 500.

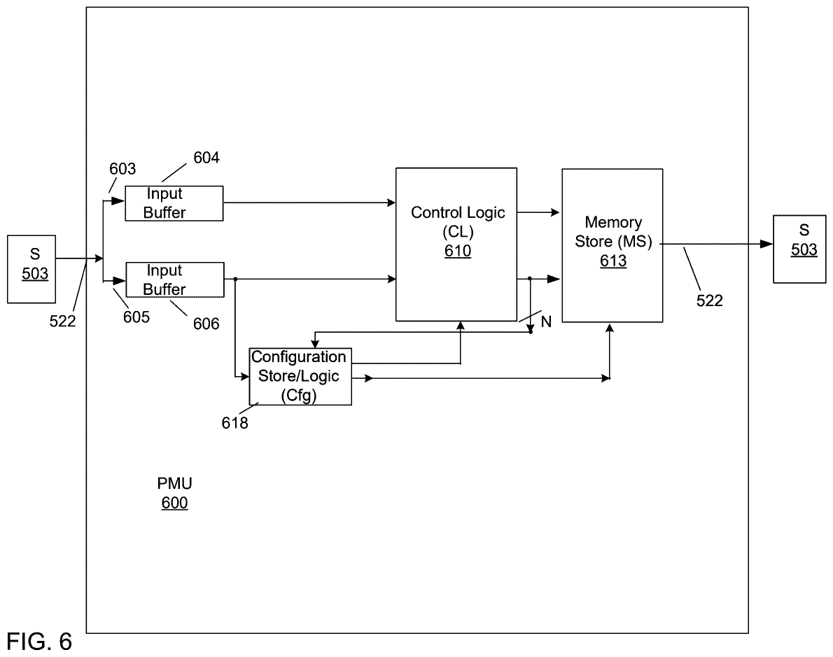

FIG. 6 illustrates a simplified block diagram of an example of an implementation of a program memory unit (PMU) 600 that may be one or more of CGRUs 501 (FIG. 5) and that may be substantially the same as or may operate substantially the same as any one of CGRUs 501. PMU 600 includes a simplified example of an implementation of a configuration store/logic circuit 618 that may be substantially the same as or may operate substantially the same as Cfg 502 (FIG. 5).

PMU 600 may include input buffers 604 and 606 that are connected to respective data bus 603 and 605 of ALN interconnect 522. One of buffers 604 or 606 may be connected to a vector bus of interconnect 522 to receive vector data from one of buses 603 or 605, and the other one of buffers 604 or 606 may be connected to a scalar bus of interconnect 522 to receive scalar data. Buffers 604 and 606 may be implemented as FIFO buffers or any other known buffer implementation.

PMU 600 includes a memory storage area or memory store circuit or memory store (MS) or MS 613 that may be configured as any type of memory of any size including SRAMS, DRAMS, flip flops, etc. An implementation of memory store (MS) 613 may be used as a memory store to sequence the reading of data that is received by a system that includes CGR array 500 (FIG. 5) such as for example system 300 (FIG. 3). For example, MS 613 may be an implementation of at least a portion of memory 316 of ACGRU 310 (FIG. 3). A portion of MS 613 may be used to form at least a portion of a k/v cache, such as for example cache 318 (FIG. 3) for speculative decoding of data received by a CGRA. Each word of the memory may have any number of bits. An implementation may include words having 128 bits per word. PMU 600 may also include control logic 610 that may assist in operating the elements of PMU 600.

During the execution of a Graph or sub-graph or Process, a computer system, such as one of the systems described in the descriptions of FIGS. 1-6, may need to process data received by the system. For example, the system may receive an input to the system as information or parameters or other data or text that is used by the graph or Process. During reception of the information, the system may be configured to predict additional information based on the initial information that is received. For example, the Graph or Process may need some type of information or data to continue running the Process. The Graph or Process may, for example, output a question or command to have some data entered into the system, and the system may receive the data in response to the question or command. As the system receives an initial part of the data, the system may control the Graph or Process to predict subsequent data by using speculative decoding of the initial data. The speculative decoding may assist forming the complete response to the initial question/command formed by the system. The Process may utilize a Target Model to assist in speculative decoding including speculating data and also for selecting the data from a group of speculated data. The Process may also utilize a Draft Model to quickly generate one or more draft data speculations based on the initial data. In an implementation, the Target Model may be a Large Language Model (LLM), or other language model or an Artificial Intelligence (AI) algorithm or other algorithm that may be capable of supporting a large number of parameters, for example five hundred billion (500 B) parameters. The large size of the Target Model assists in enhancing system performance. The Draft Model is a smaller language model that quickly generates one or more draft data speculations based on the initial data. The Draft model may be a small fast auto-regressive program or a parallel mode program or other program that is smaller and faster than the Target Model. An implementation may include that the Draft model may be a smaller language model that supports fewer parameters than the Target model., for example supports less than five hundred billion (500B) parameters or alternately less than one billion (1 B) parameters.

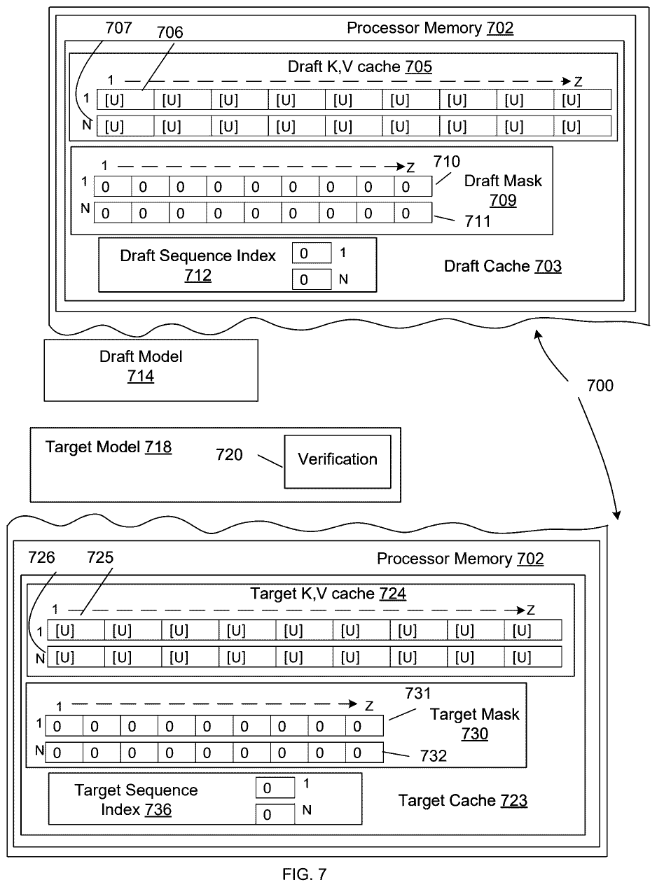

FIGS. 7-12 illustrate simplified examples of the state of some system elements that may be used for receiving an example input data and using speculative decoding to predict subsequent data. FIGS. 7-12 illustrate some example stages of the system during processing the data and also illustrate some interim data results.

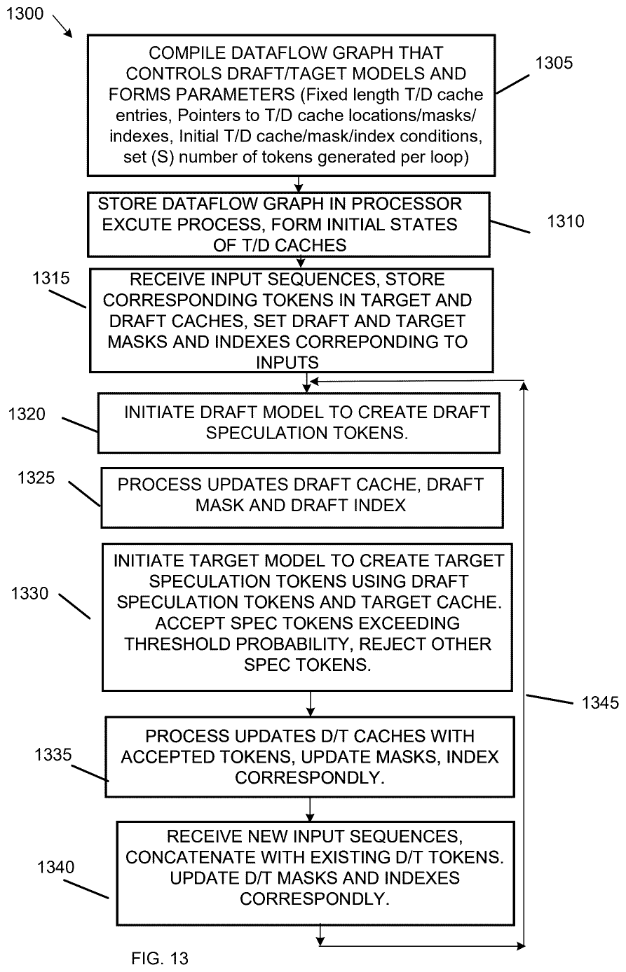

FIG. 13 illustrates a flow chart 1300 indicating in a general manner some steps in an example of a method formed by a system running a Process, such as for example a Graph, that is used for receiving input information and using speculative decoding for predicting future information. Flowchart 1300 may be illustrative of an example of some operations formed by a method during execution of the Process using a system having a Dataflow architecture such as the system explained in the description of FIGS. 3-6. The illustrated steps are examples and the Process may utilize different steps in some implementations. The following description has references to FIGS. 7-13.

Referring to FIGS. 7 and 13, at an operation 1305 a complier, such as for example complier 356 (FIG. 3), may compile a dataflow graph for the Process that includes a method for processing information and speculating additional information. The Process may include forming and managing parameters that are used by a Target model 718 and a Draft model 714 (see previous explanation of the Target and Draft models), and invoking operation of the Draft and Target models. The compiler may also create configuration files to be stored in configuration store/logic circuits of the system, such as for example Cfg 502 (FIG. 5). The configuration files have parameters that will cause the Process to form a speculation cache 700 in a processor memory 702. An implementation of memory 702 may be any memory of the system that executes the Graph or Process. For example, memory 702 may be a portion of memory 328 (FIG. 3) or memory 481 (FIG. 4). Alternately, the Process may cause the system to form cache 700 in a memory within system 400 or CGRA 410 or CGRA 412, or memory 613 (FIG. 6). Processor memory 702 may be on the same chip as the processor. For example, memory 481 may be formed on the same IC or alternately in the same package as a processor that includes CGRA 400.

An operation 1310 illustrates that the compiler may be configured to store the Process including the compiled Graph and the parameters for the Process in the system. For example, a host such as for example host 354 (FIG. 3) may use an output of the complier to store the dataflow graph and configuration files in the corresponding processor of the system. In an example, the dataflow graph may be stored in a CRM of the system or in other storage locations. CRM 331 or CRM 482 in respective FIGS. 3-4 may be examples of such a CRM.

Operation 1310 indicates that the system may initiate execution of the dataflow graph or Process. Execution of the Graph causes the system to form initial states of cache 700. An example may include using the configuration files in respective configuration stores to assist in forming cache 700.

Referring to FIG. 7, the Process causes the system executing the Graph to allocate a portion of a processor memory 702 and form cache 700 therein. For example, in a dataflow architecture, such as for example system 300 (FIG. 3) or CGRA 400 (FIG. 4), a portion of respective memory 328 or 481 may be used for cache 700. In some implementations, a portion of memory 316 (FIG. 3) or 613 (FIG. 6) may alternately be used for cache 700. The Process may form cache 700 to include a Draft cache 703 for use with Draft model 714, and form a Target cache 723 for use with Target model 718. The Process causes the system to form Target cache 723 to include a Target k/v cache 724, a Target mask 730, and a Target sequence index or Target index 736. Similarly, the Process causes the system to form Draft cache 703 to include a Draft k/v cache 705, a Draft mask 709, and a Draft sequence index or Draft index 712. Draft cache 703 and Target cache 723 may be formed by the system in different portions of processor memory 702. Target cache 723 and draft cache 703 may be referred to collectively as “T/D cache”, such as in flowchart 1300.

Since the system executing the Process may receive inputs from more than one source, both caches 705 and 724 are formed to have N number of strings wherein each of the N number of strings represents one set of information or data to be processed along with any corresponding speculated information or data for that set of information or data. As illustrated in FIG. 7, the number two (2) is used for N such that two strings are illustrated for example purposes. However, N may be any number that may be used by the system. Thus, Target k/v cache 724 has N target cache strings or target strings 725 and 726, and Draft k/v cache 705 has N draft cache strings or draft strings 706 and 707. The Process causes each string 706, 707, 725 and 726 to be formed with a fixed length, that is a fixed number of entries or fixed number of locations. The length of the string or number of entries or number of locations is a fixed number, illustrated by “Z”, and corresponds to the maximum word length in a tensor of the system. An implementation may include that the fixed length is formed prior to the system receiving any data. In an implementation, the fixed length is formed regardless of the type or amount of data to be received. For example, for a system with a tensor length having four thousand and ninety six (4096) words, the system may form each string with 4096 entries or locations, so that the number “Z” is 4096. Thus, as will be seen further hereinafter, there is a location in the string for each individual piece of information or data, for example each word of text, that is received by the system. Although each k/v cache string is shown as a block of continuous memory locations, the block of memory may be discontinuous and memory pointers or indexes may be used to identify or locate each discontinuous section of the memory block so the discontinuous memory locations are processed as one continuous memory. Thus, the locations in the strings are treated as sequential locations even though the actual memory locations may be discontinuous.

The Process also causes the system to form a mask for each of the strings. Draft mask 709 is formed with N number of Draft masks strings that correspond to the N number of Draft k/v cache strings. Draft mask string 710 represents the first Draft mask string and is associated with draft string 706, and draft mask string 711 represents the Nth Draft mask string and is associated with draft string 707. Each Draft mask string has “Z” number of locations that corresponds to the “Z” number of Draft k/v cache string locations. Similarly, Target mask 730, is formed with N number of Target mask strings that correspond to the N number of Target k/v cache strings. Target mask string 731 represents the first Target mask string and is associated with target string 725, and Target mask string 732 represents the Nth Target mask string and is associated with target string 726. Each Target mask string has “Z” number of locations that correspond to the “Z” number of locations of the Target k/v cache strings. The Process also causes the system to form Draft index 712 with N number of Draft pointers that correspond to the N number of Draft k/v cache strings, and a forms Target index 736 with N number of Target pointers that correspond to the N number of Target k/v cache strings. Each pointer of the sequence index points to the last location in a corresponding k/v cache string which is storing accepted data. The pointer in each sequence index represents a number that varies from 0 to “Z”. Upon initial configuration, the Process initiates all k/v cache string locations and all mask locations to a negated state indicating that no data has been used. The negated state of the k/v cache string locations is indicated by “[U]” and the negated state of mask locations is indicated the number “0”. Each sequence index pointer is set to “0 ” indicating that no data has been received or generated by the system. An implementation may include that the compiler is configured to form configuration files that control the system and the Process to form the initial states of the elements of cache 700 including the initial states of caches 703 and 723, including forming the fixed length of the strings for k/v caches 705 and 724, and the fixed length for masks 709 and 730.

An operation 1315 illustrates the system may receive one or more sets of data that are to be processed.

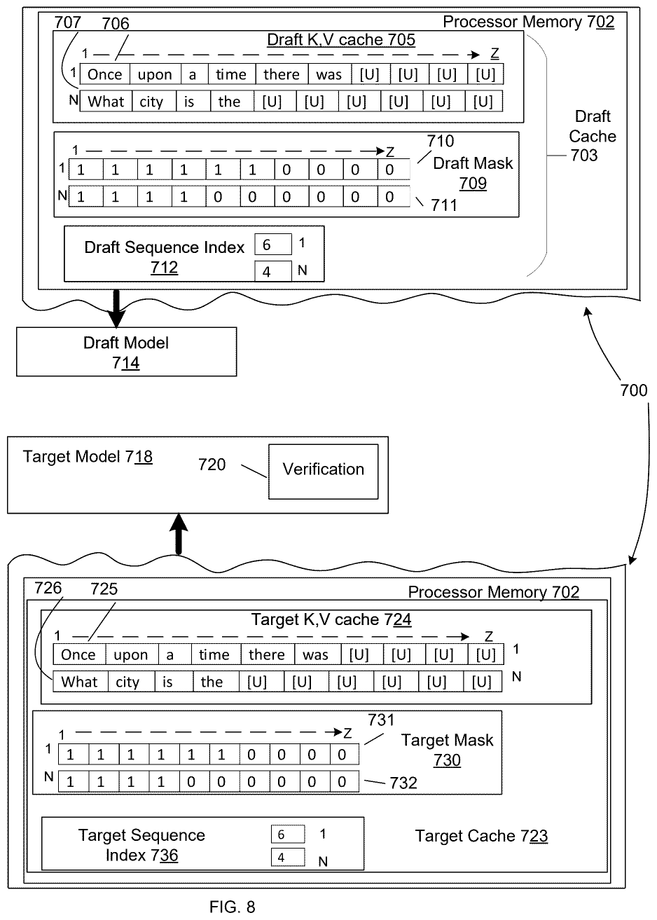

FIG. 8 illustrates an example of strings of information or data that may be received and processed by the system. Assume for example that a first string of data includes the phrase “Once upon time there was” and a second string of data is received that includes the phrase “What city is the”. The first string of data and the second string of data are converted by the system into individual tokens that represent the data. For example, the data may be converted into tokens that represent words, or sub-words, or characters, or other elements that represent the data, or alternately may be pixels or other segments of an image that may be included in the data. Thus, a token may represent one word in the phrase or a sub-word, or one or more characters of a word, or other portions of a word in the phrase. The Process stores the tokens in a location of cache 705 and 724 while maintaining the fixed length. For the two example strings of “Once upon time there was” and “What city is the”, the token or tokens for the word “Once” is/are stored in location “1” of strings 706 and 725. For clarity of the explanation of FIG. 8, the individual words themselves are illustrated in caches 705 and 724 even though the corresponding token or tokens is/are actually stored in these locations. Similarly, the token or tokens for the word “upon” is/are stored by the Process into location “2” of strings 706 and 725, and the token or tokens for the word “a” is/are stored in location “3” of strings 706 and 725. The token or tokens are well known elements used for representing or evaluating data. As used herein, the word token as referring to speculative decoding may be taken to refer to the one or more tokens that result from the conversion of one word or image. This continues for each data received. An implementation may include that each token may also include one or more keys and one or more values for each token. The keys and values are well known parameters that are used for representing and evaluating data, such as an evaluation by an LLM.

The Process causes the system to store the tokens beginning at the left most entry of each string of the caches. For example, the tokens for the phrase “Once upon time there was” are stored beginning at the first leftmost location (string location “1”) and sequentially thereafter. One implementation may include that the left most location for each string 706, 707, 725, and 726 has the lowest memory address of the memory block used for that string. For example, the lowest memory address for the block of memory locations used for string 706 and the lowest address for the block of memory locations used for string 707, etc.

As the data is received and tokens stored by the Process into caches 705 and 724, the Process updates the mask for each string to indicate which string location contains a token. The Process asserts the mask entries beginning at the left of the mask (or leftmost location) in the same manner as caches 705 and 724. For example, as the word “Once” is received, the system stores the corresponding token in location one (1) of string 706, and also asserts the corresponding mask location “1” of mask string 710 to indicate that string 706 location “1” is being used. Similarly, as the word “upon” is received, the Process stores the corresponding token in location two (2) of string 706, and also asserts the corresponding mask location “2” of mask string 710 to indicate that string 706 location “2” is being used. This continues for each data that is received. Thus, the states of cache 705 and 724 illustrate receiving six words for strings 706 and 725, and receiving four words for strings 707 and 726. Draft mask string 710 and Target mask string 731 have the first six (6) locations asserted, and Draft mask string 711 and Target mask string 732 have the first four (4) locations asserted to indicate the four tokens stored in strings 707 and 726. The Process updates the pointers of Draft index 712 and Target index 736 to indicate the number of tokens in strings 706-707 and strings 725-726. The Process also updates the first pointer of indexes 712 and 736 to the number six (6), and updates the second pointer of indexes 712 and 736 to the number four (4).

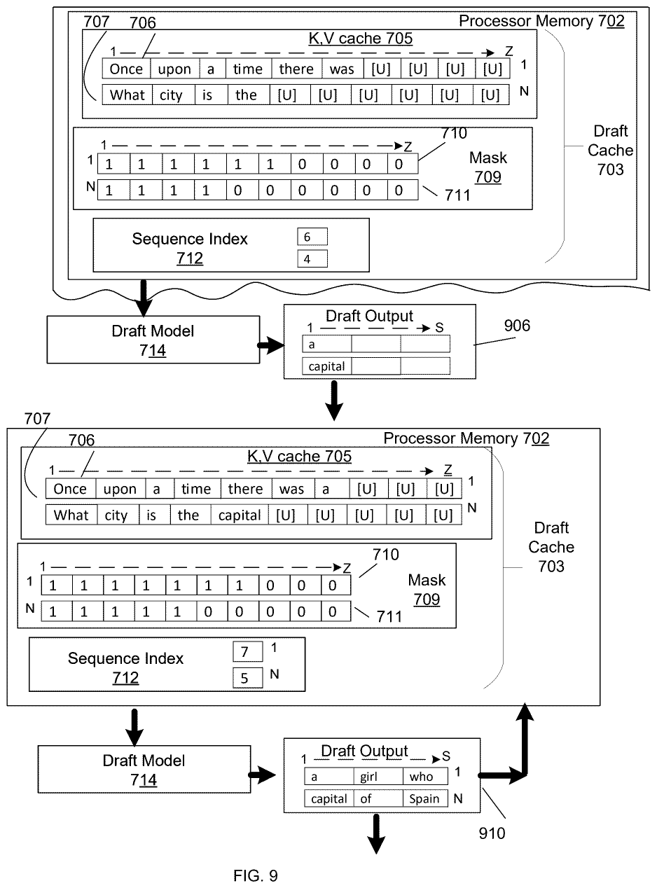

Referring to FIG. 9 and an operation 1320, the Process causes the system to initiate operation of Draft model 714 to speculate the next data in the data sequences stored in draft k/v cache 705. The Process passes the information in draft k/v cache 705 and draft mask 709 to draft model 714. Mask 709 is used to mask off portions of draft k/v cache 705 that correspond to negated locations of mask 709. Draft model 714 initiates the sequence of predicting data that might subsequently be received based on the tokens in cache 705. Draft model 714 uses the first six tokens of string 706, and the first four tokens of string 707 to predict draft tokens for the two strings. An implementation may include that the Process also passes a parameter to model 714 that controls the number of speculated tokens that is formed by model 714. This parameter is illustrated in draft outputs 906 and 910 by the letter “S”. An implementation may include that this parameter is specified by the system to the compiler that compiles the dataflow graph, and that this parameter by stored in a configuration file of the system. For this example illustration, parameter “S” is the number three (3) but may be other numbers in other implementations. Draft model 714 may speculate the S number of tokens in three subsequent passes through model 714 or alternately may speculate the S number of tokens with one pass through model 714. For example, model 714 may receive cache 705 and speculate one token for each string therein. Assume for this example that model 714 speculates one token for each pass through model 714. The speculated tokens for the first pass are illustrated in Draft output 906. Assume that Draft output 910 represents the words for the speculated tokens after model 714 speculates S number of tokens.

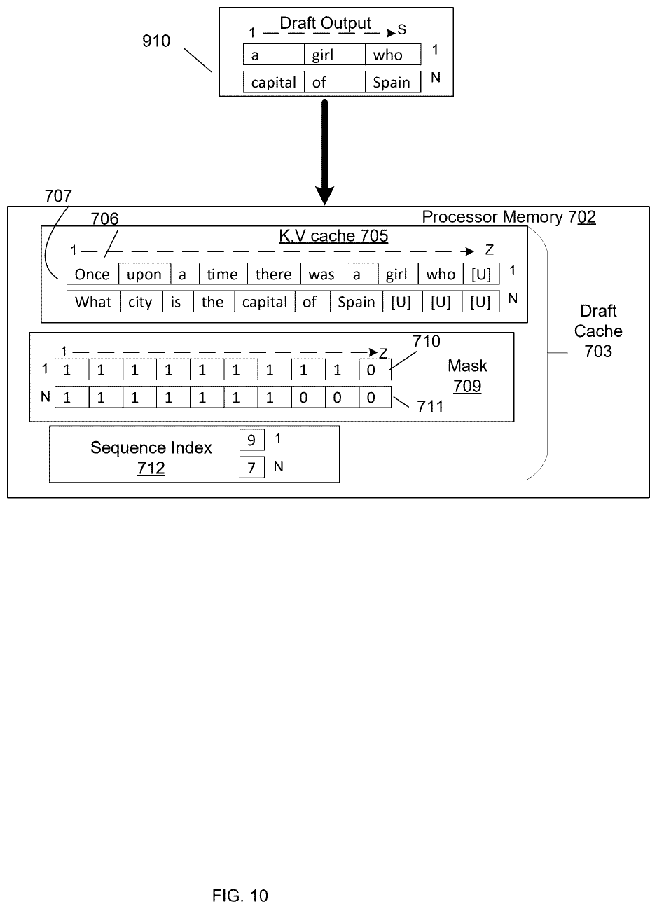

FIG. 10 and an operation 1325 illustrates the state of cache 703 after the Process causes the system to store the tokens from output 910 back into cache 705. The Process also causes the system to correspondingly update mask 709 and index 712. The Process updates mask 709 to assert the locations that have a stored token, and also updates the pointers of index 712 to indicated the number of tokens in strings 706 and 707. For this example, assume that model 714 speculated tokens for the words “a girl who” for string 706, and speculated tokens for the words “capital of Spain” for string 707. Thus, the Process stores these tokens into strings 706 and 707, asserts mask string 710 locations one through nine (1-9), and asserts mask string 711 locations one through seven (1-7). The system also updates the first pointer of index 712 to the number nine (9) and the Nth pointer to the number seven (7).

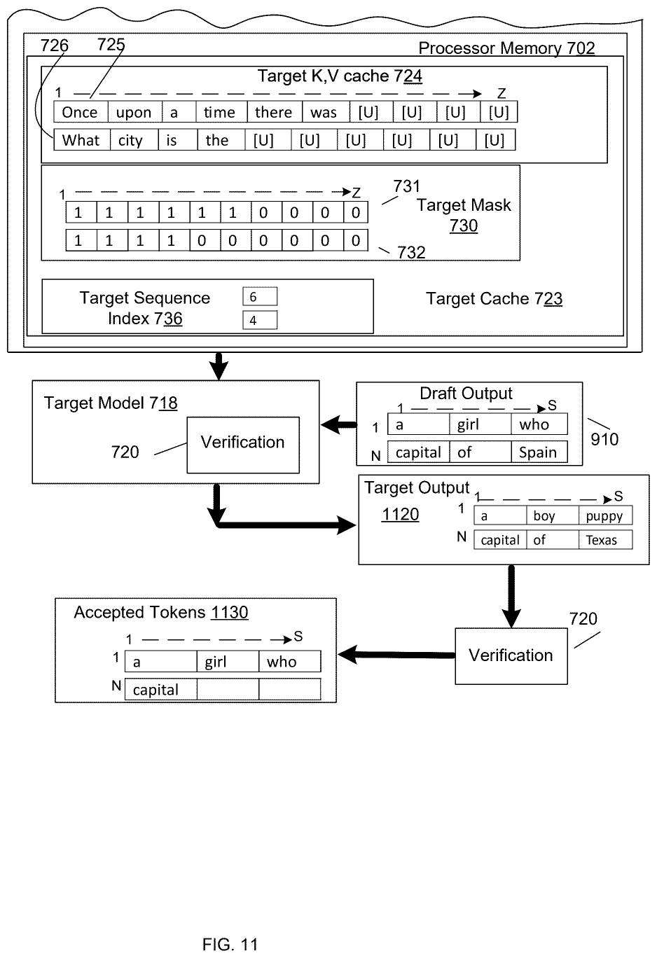

FIG. 11 and an operation 1330 illustrates the Process causing the system to initiate operation of Target model 718 to generate Target speculation tokens. The Process causes the system to pass the draft speculation tokens of output 910 to Target model 718 along with Target cache 724, Target mask 730, and Target index 736. Target model 718 generates S number of speculation tokens as illustrated by Target output 1120. An implementation of Target model 718 may generate all of the Target speculation tokens in one pass through model 718. For this example, assume that model 718 speculates tokens for the words “a boy puppy” for the next tokens of string 725, and speculates tokens for the words “capital of Texas” for the next tokens of string 726.

Target model 718 may include a verification block 720 that is used to evaluate the tokens in Draft output 910 and Target output 1120 and select the tokens that would have the highest probability of being successful as tokens subsequent to the tokens already in cache 724. For example, the Process may set some threshold of probability as being sufficient to accept a predicted word and pass the threshold probability to model 718. Verification 720 may select speculated tokens for an entire phrase or a sub-set of the entire set of speculated tokens. Assume for this example, that the tokens in Draft output 910 speculated for string 725 are accepted, but the token for the one word “capital” of the tokens speculated for string 726 is the only token accepted for string 726. The words for the accepted tokens are illustrated by accepted tokens 1130. Accepted tokens 1130 illustrate an accepted first token set of “a girl who” and an accepted second token set of “capital”. Thus, any accepted tokens can be any number of tokens. It is possible that in some cases none of the speculated draft tokens could reach the threshold limit for acceptance, thus, none would be accepted. In such a case, any accepted Target tokens could become the tokens in Accepted Tokens 1130. Additionally, it could be the case that none of the speculated draft tokens or speculated targe tokens reach the threshold for acceptance, thus there could not be any accepted tokens.

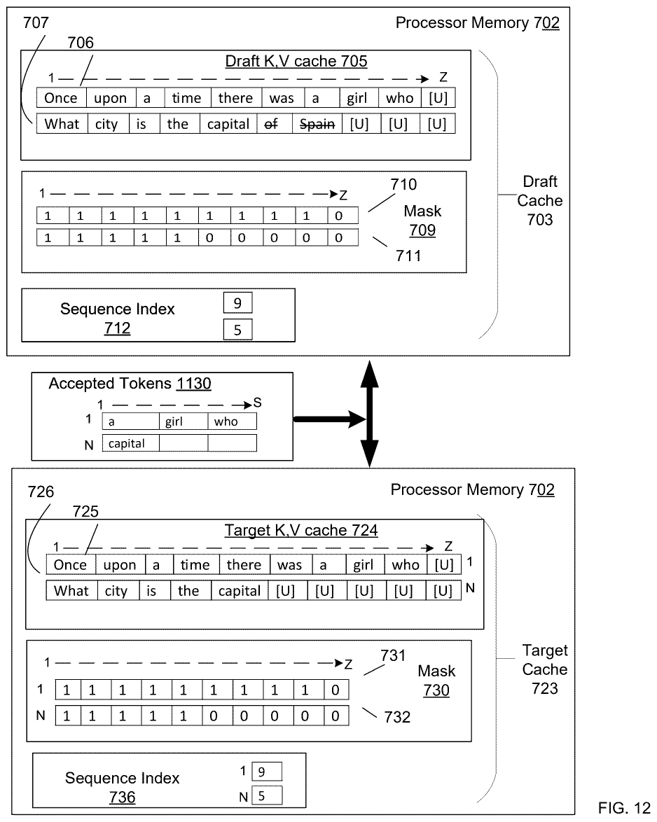

FIG. 12 and an operation 1335 illustrates examples for caches 703 and 723 after the Process causes the system to update caches 703 and 723 according to the tokens in accepted tokens 1130 while maintaining the fixed length. For Draft cache 703, draft output 910 (FIG. 10) for cache string 706 was accepted, thus there is no change to string 706. Thus, the Process stores the tokens from the first accepted token set in accepted tokens 1130 into string 706 and updates mask string 710 and the first pointer of index 712. But there is no change to the information already in these locations because they already have the correct status. Thus, the locations of mask string 710 that are asserted are correct and not changed. For target cache 723, the Process causes the system to store tokens for the words “a girl who” concatenated onto the existing tokens in cache string 725. The Process causes the system to assert the first nine locations of mask string 731 corresponding to the tokens added into string 725, and to also update or change the first pointer of index 736 to the number nine (9) to point to the last accepted location of cache string 725.

For draft sting 707 of draft cache 703, only one token from draft output 910 (FIG. 10) was accepted, the token for the word “capital”. Tokens for the words “of Spain” in draft output 1010 were not accepted. Thus, draft string 706 has to be rolled back to include only the token for the word “capital” as the last accepted token. The unaccepted tokens (“of Spain”) in string 707 are illustrated in FIG. 12 with strike through text to illustrate that they were not accepted. The Process causes the system to change the locations of mask string 711 and assert the first five (5) locations (instead of the first seven shown in FIG. 10), and negate the other locations. Because locations six and seven (6-7) of mask 711 are negated, any tokens in the corresponding locations of draft string 707 are masked off and ignored. Additionally, the Process causes the system to change the second pointer of index 712 to the number five (5) in order to point to the last accepted location of cache string 707 (instead of the number seven (7) as shown in FIG. 10). For this example, the second pointer of index 712 may be decremented to the number five (5) because the previous second pointer value of seven exceeded the number of accepted tokens. Thus, the Process rolls back cache string 707 to the last accepted token. The rollback assists the Process in only using accepted tokens. A rollback operation may be used for any string or cache that has tokens that were not accepted.

For Target cache string 726, the accepted token for the word “capital” is concatenated onto the tokens in string 726 to added the accepted token into string 726. Also, the Process causes the system to asset the first five (5) locations of mask string 732 (instead of the previous four (4) locations illustrated in FIG. 8) to correct mask string 732. The Process causes the system to update the second pointer of index 736 to the number five (5) (from the previous number 4 in FIG. 8) to point to the last accepted token in string 726. For example, the second pointer may be incremented.

Thereafter, as illustrated at an operation 1340, the Process may receive additional information from one or more of the two information sets, or from an additional data set. The Process may repeat a sequence that is illustrated in operations 1320-1335. The information is tokenized in the strings of caches 705 and 724. The Process forms tokes for the received information or data and concatenates the tokens onto any tokens already stored in the strings of caches 705 and 724. The system additionally, updates masks 709 and 730 along with indexes 712 and 736.

The Process thereafter again controls models 714 and 718 to form a new set of speculated tokens based in the accepted and newly received data, such as explained hereinbefore relating to the explanation of FIGS. 9-12 and related operations 1320-1335.

It has been found that using a fixed length or fixed size for a cache element or string that stores tokens of the decoding process, improves the performance of the system. It is believed that implementing the fixed length for the draft cache and target cache reduces processing time and improves system performance. For example, a system that dynamically adjusts the length of each sequence results in slower system performance. Furthermore, using a processor memory that is on the same chip with the processor also assists in improving the system performance. As explained hereinbefore, not all tokens are accepted, which can result in having accepted token sequences of different lengths, although the cache length remains at the fixed size. It has believed that using masks along with indexes or pointers to identify the last accepted tokens assists in rolling back the cache entries that are not accepted and assists in keeping track of the accepted tokens. This results in a simpler and faster operation. In one example dataflow architecture system, the system performance using the Process was approximately twenty-five percent (25%) faster that the system using a variable length cache.

### Particular Implementations

In one implementation a disclosed system, such as for example system 300 or system 400, may include one or more coarse grained reconfigurable processors or reconfigurable processors, such as for example processors 306, or 310, or 410, or 412, wherein at least a reconfigurable processor of the one or more reconfigurable processors is coupled to a processor memory that is configured to receive computer program instructions that, when executed on the one or more reconfigurable processors, implements actions comprising:
create a target cache, such as for example cache 723, within the processor memory, the target cache having N target strings, such as for example strings 725 or 726, that each have a fixed number of locations;
create a target mask, such as for example mask 730, within the processor memory, the target mask having N target mask strings, such as for example strings 731 or 732, that each have the fixed number of locations, wherein the fixed number of locations of the N target mask strings are all negated;
create N target pointers, such as for example the pointers in index 736, within the processor memory, the N target pointers corresponding to the N target strings such that every target string has a corresponding target pointer;
create a draft cache, such as for example cache 703, within the processor memory, the draft cache having N draft strings, such as for example strings 706, or 707, that each have the fixed number of locations;
create a draft mask, such as for example mask 709, within the processor memory, the draft mask having N draft mask strings, such as for example mask strings 710, or 711, that each have the fixed number of locations, wherein the fixed number of locations of the N draft mask strings are all negated;
create N draft pointers, such as for example the pointers in index 736, within the processor memory, the N draft pointers corresponding to the N draft strings such that every draft string has a corresponding draft pointer;
receive a first information set and convert the first information set into a first token set that corresponds to information in the first information set, the first token set having a first number of tokens that is less than the fixed number of locations;
receive a second information set and convert the second information set into a second token set that corresponds to information in the second information set, the second token set having a second number of tokens that is less than the fixed number of locations;
store the first token set into a first draft string, such as for example string 706, of the N draft strings as a first draft token set having the first number of draft tokens, and store the first token set into a first target string, such as for example string 725, of the N target strings as a first target token set having the first number of target tokens;
assert a first number of locations of a first draft mask string, such as for example string 710, of the N draft mask strings, wherein the first number of locations of the first draft mask string corresponds to the first number of draft tokens, and assert a first number of locations of a first target mask string, such as for example string 731, of the N target mask strings wherein the first number of locations of the first target mask string corresponds to the first number of target tokens;
update a first draft pointer of the N draft pointers to indicate the first number of draft tokens, and update a first target pointer of the N target pointers to indicate the first number of target tokens;
store the second token set into a second draft string, such as for example string 707, of the N draft strings as a second draft token set having the second number of draft tokens, and store the second token set into a second target string, such as for example string 726, of the N target strings as a second target token set having the second number of target tokens;
assert a second number of locations of a second draft mask string, such as for example mask string 711, of the N draft mask strings, wherein the second number of locations of the second draft mask string corresponds to the second number of draft tokens, and assert a second number of locations of a second target mask string, such as for example mask string 732, of the N target mask strings wherein the second number of locations of the second target mask string corresponds to the second number of target tokens;
update a second draft pointer of the N draft pointers to indicate the second number of draft tokens, and update a second target pointer of the N target pointes to indicate the second number of target tokens;
   the system may initiate execution of a speculation sequence including:
   execute a Draft model, such as for example Draft Model 714, to use the draft cache and the draft mask as inputs to generate a third number of a new first draft tokens that are sequential to the first draft token set, and generate a fourth number of a new second draft tokens that are sequential to the second draft token set including using draft tokens from the draft cache that correspond to draft mask locations having an asserted state;
   execute a Target model, such as for example Target Model 718, to use the target cache, the target mask, the new first draft tokens, and the new second draft tokens as inputs to generate a fifth number of new first target tokens that are sequential to the first target token set, and generate a sixth number of new second target tokens that are sequential to the second target token set, including using target tokens from the target cache that correspond to target mask locations having an asserted state;
   wherein the target model identifies ones of the new first draft tokens and the new first target tokens that most likely are consistent with the first target token set and forms an accepted first token set, such as for example as illustrated in Accepted Tokens 1130, the accepted first token set having a seventh number of tokens;
   wherein the target model identifies the new second draft tokens and the new second target tokens that most likely are consistent with the second target token set and forms an accepted second token set, the accepted second token set having an eighth number of tokens;
the system further implementing actions to:
store the accepted first token set into the first draft string concatenated to the first draft token set, and store the accepted first token set into the first target string concatenated to the first target token set;
assert locations of the first draft mask string and the first target mask string that correspond to the accepted first token set stored into the first draft string and stored into the first target string;
change the first draft pointer to include the accepted first token set stored into the first draft string, and change the first target pointer to include the accepted first token set stored into the first target string;
store the accepted second token set into the second draft string concatenated to the second draft token set, and store the accepted second token set into the second target string concatenated to the second target token set;
assert locations of the second draft mask string and the second target mask string that correspond to the accepted second token set stored into the second draft string and the second target string; and
change the second draft pointer to include the accepted second token set stored into the second draft string, and change the second target pointer to include the accepted second token set stored into the second target string.

The system may also have an implementation that may include changing the first draft pointer to a first value that includes the first number of draft tokens plus the seventh number of the accepted first token set, and may additionally include changing the first target pointer to a second value that includes the first number of target tokens plus the seventh number of the accepted first token set.

Another implementation may include changing the second draft pointer to a third value that includes the second number of draft tokens plus the eighth number of the accepted second token set, and may also include changing the second target pointer to a fourth value that includes the second number of target tokens plus the eighth number of the accepted second token set.

An implementation may include store the first token set into the first draft string without changing the fixed number of locations.

Another implementation may include that the first token set is stored into the first target string without changing the fixed number of locations.

An implementation may include that the accepted second token set is stored into the second draft string and into the second target string without changing the fixed number of locations.

In some implementation the fixed number of locations may be four thousand and ninety six locations.

Another implementation may include a non-transitory computer readable storage medium (CRM) for storing computer program instructions for the system.

In an implementation the computer program instructions initiate execution of the Draft model and initiate execution of the Target model.

An implementation may include storing the first token set into the first draft string beginning at a first location of the first draft string and continuing sequentially from the first location.

Another implementation may include storing the first token set into the first target string beginning at a leftmost location of the first target string and continuing sequentially from the leftmost location.

The system may have an implementation that further includes, after an operation to assert locations of the second draft mask string, the system implementing actions causing the system to:
receive a first addition to the first information set and convert the first addition into a first new token set that corresponds to information in the first addition, the first new token set having a first additional number of first new tokens;
receive a second addition to the second information set and convert the second addition into a second new token set that corresponds to information in the second addition, the second new token set having a second additional number of second new tokens;
concatenate the first new token set into the first draft string, such as for example into string 706, and concatenate the first new token set into the first target string, such as for example into string 725, of the N target strings;
assert locations of the first draft mask string, such as for example locations of string 710, that correspond to the first new token set, and assert locations of the first target mask string, such as for example locations of string 731, that corresponds to the first new token set;
update the first draft pointer to a first value that includes the first new token set added into existing entries in the first draft string, and update the first target pointer to a second value that includes the first new token set added into existing entries in the first target string;
execute the speculation sequence; and
concatenated a first new accepted token set into the first draft string and the first target string.

Those skilled in the art will appreciate that computer implemented method for predicting new information based on a received information sequence, wherein the computer include a memory and may include a coarse grained reconfigurable processor, the method may comprise:
forming a draft cache, such as for example cache 703, within the memory including forming a first number of draft cache strings, such as for example strings 705 or 706, for receiving tokens representing the received information sequence and for receiving other tokens representing new predicted information, the draft cache strings having a fixed number of locations, including forming a draft mask having the first number of draft mask strings such that each draft cache string has a corresponding draft mask string, the first number of draft mask strings having the fixed number of locations including negating the fixed number of locations of the draft mask strings, and forming draft pointers such that each draft cache string has a corresponding draft pointer;
forming a target cache, such as for example cache 723, within the memory including forming the first number of target cache strings for receiving tokens representing the received information sequence and for receiving tokens representing new predicted information, the target cache strings having the fixed number of locations, including forming a target mask having the first number of target mask strings such that each target cache string has a corresponding target mask string, the first number of target mask strings having the fixed number of locations including negating the fixed number of locations of the target mask strings, and further including forming target pointers such that each target cache string has a corresponding target pointer;
storing tokens in the draft cache strings and target cache strings including storing tokens beginning with a left most entry in the draft cache string and beginning with a left most entry in the target cache string;
asserting draft mask string locations that correspond to the tokens stored in the draft cache string and asserting target mask string locations that correspond to the tokens stored in the target cache string;
forming draft pointer values and target pointer values that correspond to the tokens stored into the corresponding draft cache string and target cache string;
   the method may cause executing a speculation sequence that includes:
   causing execution of a Draft model, such as for example Model 714, that uses the draft cache to form new draft tokens, such as for example the tokens illustrated in Draft Output 910,
   causing execution of a Target model, such as for example Target model 718, that uses the target cache and the new draft tokens to form an any accepted tokens, such as for example tokens illustrated in Accepted Tokens 1130;
the method further including;
storing the any accepted tokens into the draft cache string by concatenating the any accepted tokens onto tokens previously stored in the draft cache string, and storing the any accepted tokens into the target cache string by concatenating the any accepted tokens onto tokens previously stored in the target cache string;
asserting draft mask string locations that correspond to the any accepted tokens and the tokens previously stored in the draft cache string while negating other draft mask string locations, asserting target mask string locations that correspond to the any accepted tokens and the tokens previously stored in the target cache string while negating other target mask string locations; and
changing values of the draft pointers and values of the target pointers to correspond to tokens in the corresponding draft string and target string.

An implementation of the method may include beginning storing the tokens into a lowest number of the fixed number of locations and continuing sequentially therefrom; and
wherein storing tokens into the target cache strings includes beginning storing the tokens into a lowest number of the fixed number of locations and continuing sequentially therefrom.

Another implementation may further include, after operations causing execution of the Draft model;
storing the new draft tokens into the draft cache strings wherein the new draft tokens are concatenated onto previous tokens stored into the draft cache strings, and updating the draft mask strings and updating the draft pointers correspondingly;
wherein asserting draft mask string locations includes negating any previously asserted mask sting locations that do not correspond to the any accepted tokens; and
wherein changing draft pointer values includes decrementing draft pointer values that exceed a number corresponding to previously stored draft tokens plus the any accepted tokens.

Those skilled in the art will appreciate that a method implemented on a computer for predicting new information based on a received information sequence, the computer having a memory and including a coarse grained reconfigurable processor, the method may comprise:
creating a draft cache, such as for example cache 703, within the memory including forming draft strings configured to store tokens that are representative of received information and store accepted tokens representing speculated information, the draft strings having a fixed length;
creating a draft mask having draft mask strings that correspond to locations of the draft strings, the draft mask strings having the fixed length;
creating a target cache, such as for example cache 703, within the memory including forming target strings configured to store tokens that are representative of received information and store accepted tokens representing speculated information, the target strings having the fixed length;
creating a target mask having target mask strings that correspond to locations of the target strings, the target mask strings having the fixed length;
storing a first set of tokens, such as for example tokens illustrated in FIG. 8, into the draft cache as draft tokens while maintaining the fixed length, and storing the first set of tokens into the target cache as target tokens while maintaining the fixed length wherein the first set of tokens represent a first set of information;
asserting locations of the draft mask that correspond to the first set of tokens stored into the draft cache, and asserting locations of the target mask that correspond to the first set of tokens stored into the target cache;
using the draft cache and target cache as inputs for predicting an any accepted tokens, such as for example the tokens illustrated in Accepted Tokens 1130, that represent speculated information subsequent to tokens in the draft cache and target cache;
storing the any accepted tokens into the target cache concatenated with target tokens therein while maintaining the fixed length, and storing the any accepted tokens into the draft cache concatenated with any previous accepted tokens while maintaining the fixed length;
asserting locations of the draft mask that correspond to any previous accepted draft tokens and the any accepted tokens stored into the draft cache, and negating other draft mask locations while maintaining the fixed length; and
asserting locations of the target mask that correspond to the any accepted tokens stored into the target cache while maintaining the fixed length.

Another implementation may include;
using the draft cache and draft mask as inputs to a draft model and causing the draft model to speculate new draft tokens; and
using the target cache, the target mask, and the new draft tokens as inputs to a target model and causing the target model to form the any accepted tokens including using only target cache locations that correspond to asserted target mask locations.

The method may have an implementation that further includes repeating a sequence that includes:
using the draft cache and target cache as inputs for predicting other accepted tokens;
storing the other accepted tokens into the target cache concatenated with target tokens therein, and storing the other accepted tokens into the draft cache; and
and updating the draft mask strings and updating the target mask strings.

Another implementation may include storing a first token of the first set of tokens into a lowest number of the fixed length and continuing sequentially therefrom.

In an implementation, the method may further include forming a draft pointer for the draft cache and creating a target pointer for the target cache; and
incrementing the target pointer for tokens stored into the target cache, and one of decrementing or incrementing the draft pointer for tokens stored into the draft cache.

In view of all of the above, it is evident that a novel system and method is disclosed. Included, among other features, is a method that includes forming a cache for storing tokes of one or more series of information. Even though the different information series may have different lengths, each cache is formed to have the same fixed length or same fixed number of entries for tokens. The tokens for each series is stored in the corresponding cache starting with the leftmost end of the cache. A mask is formed for each cache or each series. The mask has the same fixed length. The mask entries are negated for cache locations that do not have an accepted token. As new tokens are speculated, the accepted tokens are concatenated onto the existing tokens. For tokens that are not accepted, the corresponding mask locations are negated so that such tokens will not be used. Indexes or pointers are used to point to the last accepted token in the cache, one pointer for each series of information. The mask and pointers assist in keeping track of the accepted tokens which assists in more rapid system performance. The fixed size of each cache fits with the maximum word size of the system which results in the system more easily processing the information, thus, results in faster system response.

While the subject matter of the descriptions are described with specific implementations and example implementations, the foregoing drawings and descriptions thereof depict only typical and non-limiting examples of implementations of the subject matter and are not therefore to be considered to be limiting of its scope, it is evident that many alternatives and variations will be apparent to those skilled in the art. As will be appreciated by those skilled in the art, the example form of systems 100, 200, 300 and 400 are used as a vehicle to explain the operation method of controlling the computer to form the cache elements. The systems may be configured with various other implementations in addition to the illustrated implementations as long as they form the caches with a fixed length, and add tokens into the cache starting at the leftmost positions of the cache, and also control the value of associated pointers and controlling negating mask entries.

As the claims hereinafter reflect, inventive aspects may lie in less than all features of a single foregoing disclosed implementation(s). Thus, the hereinafter expressed claims are hereby expressly incorporated into this Detailed Description, with each claim standing on its own as a separate implementation of an implementation. Furthermore, while some implementations described herein include some but not other features included in other implementations, combinations of features of different implementations are meant to be within the scope of the claims and implementations, and form different implementations, as would be understood by those skilled in the art.

1. A system including one or more coarse grained reconfigurable processors or reconfigurable processors wherein at least a reconfigurable processor of the one or more reconfigurable processors is coupled to a processor memory that is configured to receive computer program instructions that, when executed on the one or more reconfigurable processors, implements actions comprising:
create a target cache within the processor memory, the target cache having N target strings that each have a fixed number of locations;
create a target mask within the processor memory, the target mask having N target mask strings that each have the fixed number of locations, wherein the fixed number of locations of the N target mask strings are all negated;
create N target pointers within the processor memory, the N target pointers corresponding to the N target strings such that every target string has a corresponding target pointer;
create a draft cache within the processor memory, the draft cache having N draft strings that each have the fixed number of locations;
create a draft mask within the processor memory, the draft mask having N draft mask strings that each have the fixed number of locations, wherein the fixed number of locations of the N draft mask strings are all negated;
create N draft pointers within the processor memory, the N draft pointers corresponding to the N draft strings such that every draft string has a corresponding draft pointer;
receive a first information set and convert the first information set into a first token set that corresponds to information in the first information set, the first token set having a first number of tokens that is less than the fixed number of locations;
receive a second information set and convert the second information set into a second token set that corresponds to information in the second information set, the second token set having a second number of tokens that is less than the fixed number of locations;
store the first token set into a first draft string of the N draft strings as a first draft token set having the first number of draft tokens, and store the first token set into a first target string of the N target strings as a first target token set having the first number of target tokens;
assert a first number of locations of a first draft mask string of the N draft mask strings, wherein the first number of locations of the first draft mask string corresponds to the first number of draft tokens, and assert a first number of locations of a first target mask string of the N target mask strings wherein the first number of locations of the first target mask string corresponds to the first number of target tokens;
update a first draft pointer of the N draft pointers to indicate the first number of draft tokens, and update a first target pointer of the N target pointers to indicate the first number of target tokens;
store the second token set into a second draft string of the N draft strings as a second draft token set having the second number of draft tokens, and store the second token set into a second target string of the N target strings as a second target token set having the second number of target tokens;
assert a second number of locations of a second draft mask string of the N draft mask strings, wherein the second number of locations of the second draft mask string corresponds to the second number of draft tokens, and assert a second number of locations of a second target mask string of the N target mask strings wherein the second number of locations of the second target mask string corresponds to the second number of target tokens;
update a second draft pointer of the N draft pointers to indicate the second number of draft tokens, and update a second target pointer of the N target pointes to indicate the second number of target tokens;
execute a speculation sequence including:
execute a Draft model to use the draft cache and the draft mask as inputs to generate a third number of a new first draft tokens that are sequential to the first draft token set, and generate a fourth number of a new second draft tokens that are sequential to the second draft token set including using draft tokens from the draft cache that correspond to draft mask locations having an asserted state;
execute a Target model to use the target cache, the target mask, the new first draft tokens, and the new second draft tokens as inputs to generate a fifth number of new first target tokens that are sequential to the first target token set, and generate a sixth number of new second target tokens that are sequential to the second target token set, including using target tokens from the target cache that correspond to target mask locations having an asserted state;
wherein the target model identifies ones of the new first draft tokens and the new first target tokens that most likely are consistent with the first target token set and forms an accepted first token set, the accepted first token set having a seventh number of tokens;
wherein the target model identifies the new second draft tokens and the new second target tokens that most likely are consistent with the second target token set and forms an accepted second token set, the accepted second token set having an eighth number of tokens;
the system further implementing actions to:
store the accepted first token set into the first draft string concatenated to the first draft token set, and store the accepted first token set into the first target string concatenated to the first target token set;
assert locations of the first draft mask string and the first target mask string that correspond to the accepted first token set stored into the first draft string and stored into the first target string;
change the first draft pointer to include the accepted first token set stored into the first draft string, and change the first target pointer to include the accepted first token set stored into the first target string;
store the accepted second token set into the second draft string concatenated to the second draft token set, and store the accepted second token set into the second target string concatenated to the second target token set;
assert locations of the second draft mask string and the second target mask string that correspond to the accepted second token set stored into the second draft string and the second target string; and
change the second draft pointer to include the accepted second token set stored into the second draft string, and change the second target pointer to include the accepted second token set stored into the second target string.

2. The system of claim 1 wherein change the first draft pointer includes changing the first draft pointer to a first value that includes the first number of draft tokens plus the seventh number of the accepted first token set, and wherein change the first target pointer includes changing the first target pointer to a second value that includes the first number of target tokens plus the seventh number of the accepted first token set.

3. The system of claim 2 wherein change the second draft pointer includes changing the second draft pointer to a third value that includes the second number of draft tokens plus the eighth number of the accepted second token set, and wherein change the second target pointer includes changing the second target pointer to a fourth value that includes the second number of target tokens plus the eighth number of the accepted second token set.

4. The system of claim 1 wherein store the first token set includes store the first token set into the first draft string without changing the fixed number of locations.

5. The system of claim 1 wherein store the first token set includes store the first token set into the first target string without changing the fixed number of locations.

6. The system of claim 1 wherein store the accepted second token set includes store the accepted second token set into the second draft string and into the second target string without changing the fixed number of locations.

7. The system of claim 1 wherein create the target cache includes forming the fixed number of locations to be four thousand and ninety six locations.

8. The system of claim 1 further including a non-transitory computer readable storage medium (CRM) for storing computer program instructions for the system.

9. The system of claim 1 wherein the computer program instructions initiate execution of the Draft model and initiate execution of the Target model.

10. The system of claim 1 further including storing the first token set into the first draft string beginning at a first location of the first draft string and continuing sequentially from the first location.

11. The system of claim 1 further including storing the first token set into the first target string beginning at a leftmost location of the first target string and continuing sequentially from the leftmost location.

12. The system of claim 1 further including, after an operation to assert locations of the second draft mask string, the system implementing actions causing the system to:
receive a first addition to the first information set and convert the first addition into a first new token set that corresponds to information in the first addition, the first new token set having a first additional number of first new tokens;
receive a second addition to the second information set and convert the second addition into a second new token set that corresponds to information in the second addition, the second new token set having a second additional number of second new tokens;
concatenate the first new token set into the first draft string, and concatenate the first new token set into the first target string of the N target strings;
assert locations of the first draft mask string that correspond to the first new token set, and assert locations of the first target mask string that corresponds to the first new token set;
update the first draft pointer to a first value that includes the first new token set added into existing entries in the first draft string, and update the first target pointer to a second value that includes the first new token set added into existing entries in the first target string;
execute the speculation sequence; and
concatenated a first new accepted token set into the first draft string and the first target string.

13. A computer implementing a method for predicting new information based on a received information sequence, the computer having a memory and including a coarse grained reconfigurable processor, the method comprising:
forming a draft cache within the memory including forming a first number of draft cache strings for receiving tokens representing the received information sequence and for receiving other tokens representing new predicted information, the draft cache strings having a fixed number of locations, including forming a draft mask having the first number of draft mask strings such that each draft cache string has a corresponding draft mask string, the first number of draft mask strings having the fixed number of locations including negating the fixed number of locations of the draft mask strings, and forming draft pointers such that each draft cache string has a corresponding draft pointer;
forming a target cache within the memory including forming the first number of target cache strings for receiving tokens representing the received information sequence and for receiving tokens representing new predicted information, the target cache strings having the fixed number of locations, including forming a target mask having the first number of target mask strings such that each target cache string has a corresponding target mask string, the first number of target mask strings having the fixed number of locations including negating the fixed number of locations of the target mask strings, and further including forming target pointers such that each target cache string has a corresponding target pointer;
storing tokens in the draft cache strings and target cache strings including storing tokens beginning with a left most entry in the draft cache string and beginning with a left most entry in the target cache string;
asserting draft mask string locations that correspond to the tokens stored in the draft cache string and asserting target mask string locations that correspond to the tokens stored in the target cache string;
forming draft pointer values and target pointer values that correspond to the tokens stored into the corresponding draft cache string and target cache string;
executing a speculation sequence that includes:
causing execution of a Draft model that uses the draft cache to form new draft tokens;
causing execution of a Target model that uses the target cache and the new draft tokens to form an any accepted tokens;
the method further including;
storing the any accepted tokens into the draft cache string by concatenating the any accepted tokens onto tokens previously stored in the draft cache string, and storing the any accepted tokens into the target cache string by concatenating the any accepted tokens onto tokens previously stored in the target cache string;
asserting draft mask string locations that correspond to the any accepted tokens and the tokens previously stored in the draft cache string while negating other draft mask string locations, asserting target mask string locations that correspond to the any accepted tokens and the tokens previously stored in the target cache string while negating other target mask string locations; and
changing values of the draft pointers and values of the target pointers to correspond to tokens in the corresponding draft string and target string.

14. The method of claim 13 wherein storing tokens into the draft cache strings includes beginning storing the tokens into a lowest number of the fixed number of locations and continuing sequentially therefrom; and
wherein storing tokens into the target cache strings includes beginning storing the tokens into a lowest number of the fixed number of locations and continuing sequentially therefrom.

15. The method of claim 13 further including, after operations causing execution of the Draft model, storing the new draft tokens into the draft cache strings wherein the new draft tokens are concatenated onto previous tokens stored into the draft cache strings, and updating the draft mask strings and updating the draft pointers correspondingly;
wherein asserting draft mask string locations includes negating any previously asserted mask sting locations that do not correspond to the any accepted tokens; and
wherein changing draft pointer values includes decrementing draft pointer values that exceed a number corresponding to previously stored draft tokens plus the any accepted tokens.

16. A method implemented on a computer for predicting new information based on a received information sequence, the computer having a memory and including a coarse grained reconfigurable processor, the method comprising:
creating a draft cache within the memory including forming draft strings configured to store tokens that are representative of received information and store accepted tokens representing speculated information, the draft strings having a fixed length;
creating a draft mask having draft mask strings that correspond to locations of the draft strings, the draft mask strings having the fixed length;
creating a target cache within the memory including forming target strings configured to store tokens that are representative of received information and store accepted tokens representing speculated information, the target strings having the fixed length;
creating a target mask having target mask strings that correspond to locations of the target strings, the target mask strings having the fixed length;
storing a first set of tokens into the draft cache as draft tokens while maintaining the fixed length, and storing the first set of tokens into the target cache as target tokens while maintaining the fixed length wherein the first set of tokens represent a first set of information;
asserting locations of the draft mask that correspond to the first set of tokens stored into the draft cache, and asserting locations of the target mask that correspond to the first set of tokens stored into the target cache;
using the draft cache and target cache as inputs for predicting an any accepted tokens that represent speculated information subsequent to tokens in the draft cache and target cache;
storing the any accepted tokens into the target cache concatenated with target tokens therein while maintaining the fixed length, and storing the any accepted tokens into the draft cache concatenated with any previous accepted tokens while maintaining the fixed length;
asserting locations of the draft mask that correspond to any previous accepted draft tokens and the any accepted tokens stored into the draft cache, and negating other draft mask locations while maintaining the fixed length; and
asserting locations of the target mask that correspond to the any accepted tokens stored into the target cache while maintaining the fixed length.

17. The method of claim 16 wherein using the draft cache and target cache as inputs for predicting any accepted tokens includes:
using the draft cache and draft mask as inputs to a draft model and causing the draft model to speculate new draft tokens; and
using the target cache, the target mask, and the new draft tokens as inputs to a target model and causing the target model to form the any accepted tokens including using only target cache locations that correspond to asserted target mask locations.

18. The method of claim 16 further including repeating a sequence that includes:
using the draft cache and target cache as inputs for predicting other accepted tokens (FIG. 11, 1130);
storing the other accepted tokens into the target cache concatenated with target tokens therein, and storing the other accepted tokens into the draft cache; and
and updating the draft mask strings and updating the target mask strings.

19. The method of claim 16 wherein storing the first set of tokens into the target cache and into the draft cache includes storing a first token of the first set of tokens into a lowest number of the fixed length and continuing sequentially therefrom.

20. The method of claim 16 further including forming a draft pointer for the draft cache and creating a target pointer for the target cache; and
incrementing the target pointer for tokens stored into the target cache, and one of decrementing or incrementing the draft pointer for tokens stored into the draft cache.
